(19) United States
(12) Patent Application Publication
(10) Pub. No.: US 2012/0308144 A1
(43) Pub. Date: Dec. 6, 2012

(54) IMAGE PROCESSING DEVICE, IMAGE PROCESSING METHOD, RECORDING MEDIUM, AND PROGRAM

(75) Inventors: Nodoka TOKUNAGA, Tokyo (JP); Takefumi NAGUMO, Kanagawa (JP)

(73) Assignee: Sony Corporation, Tokyo (JP)

(21) Appl. No.: 13/451,979

(22) Filed: Apr. 20, 2012

(30) Foreign Application Priority Data
Jun. 1, 2011 (JP) 2011-123193

(51) Int. Cl. G06K 9/52

(52) U.S. Cl. 382/206

(57) ABSTRACT

A clustering unit obtains a distance between a local motion vector obtained per block of a predetermined size and a representative motion vector for each of clusters stored in a delay buffer, classifies the local motion vector into a cluster to which the motion vector having the shortest distance belongs, and outputs the information of the classified clusters and the local motion vectors. Average value calculation units accumulate an average motion vector by accumulating the local motion vectors of the respective clusters, and output the average motion vector as a motion vector representing the cluster. A global motion vector determination unit outputs the motion vector having the largest number of elements in its cluster among the motion vectors representing the clusters as the global motion vector. The present technology may be applied an image processing device.

### BACKGROUND

The present technology relates to an image processing device, an image processing method, a recording medium, and a program, and in particular, to an image processing device, an image processing method, a recording medium, and a program that can correctly detect motion vectors even when a plurality of objects making different motions are included in an image.

Compressing moving images is realized by detecting motion vectors per macroblocks of respective frames and reducing the number of frames to be compressed using the detected motion vectors. A technique of detecting the motion vectors from the moving image is thus necessary in a process of compressing moving images.

For example, a technique of grouping motion vectors of macroblocks and detecting motion vectors of regions included in a group where a moving object is not included as motion vectors of an entire screen is proposed as the technique of detecting the motion vectors from the moving image (see Japanese Laid-Open Patent Publication No. 2007-235769).

In addition, a technique of detecting motion vectors of an entire screen using a histogram of the motion vectors and not using the motion vectors of the entire screen when concentrated motions are not present is proposed (see Japanese Laid-Open Patent Publication Nos. 2008-236098 and 2010-213287).

In addition, a technique of detecting motion vectors of an entire screen using characteristic point regions of a main object and using the motion vectors of the entire screen as motion vectors is proposed (see Japanese Laid-Open Patent Publication No. 10-210473).

In addition, a technique of detecting characteristic points, obtaining motions of the characteristic points by means of a dense search method or a k-means method, and using the motions of the characteristic points as motion vectors is proposed (see Japanese Laid-Open Patent Publication No. 2010-118862).

### SUMMARY

However, the techniques mentioned above cannot handle motions other than translation. In addition, when a scene changes or the reliability of the motion vector is low, motion vectors may be detected incorrectly, causing errors to occur on the image due to a coding process or a decoding process, because the techniques are not configured to exclude motion vectors having low reliability.

In addition, in the techniques mentioned above, when concentrated motions are not present only in one frame due to an influence such as noise or the like, vectors in the previous frame cannot be used, and motion vectors may be detected incorrectly, causing errors to occur on the image due to a coding process or a decoding process.

In addition, since motions of the entire screen are not obtained when characteristic points are not obtained from the image, the motion vector itself is not obtained, and thus the coding process itself may not be implemented.

In light of the above, the present technology enables motion vectors to be properly detected from an image.

According to an embodiment of the present technology, there is provided an image processing device including: a clustering unit configured to cluster local motion vectors per blocks of an input image into a predetermined number of clusters; and a global motion vector selection unit configured to set a representative local motion vector for each of the predetermined number of clusters made by the clustering unit and select a global motion vector of the input image from the representative local motion vectors of the respective clusters.

According to another embodiment of the present technology, there is provided an image processing device including: a local motion vector detection unit configured to detect a local motion vector per block using block matching between an input image and a reference image; a clustering unit configured to cluster the local motion vector per block into a predetermined number of clusters based on a distance between the local motion vector per block and a vector set for each of the predetermined number of clusters; a representative calculation unit configured to calculate a representative local motion vector representing each cluster made by the clustering unit; and a global motion vector selection unit configured to select a global motion vector of the input image from the representative local motion vectors of the respective clusters based on the number of local motion vectors in each cluster.

The clustering unit may include a distance calculation unit configured to calculate a distance between the local motion vector per block and a vector set for each of a predetermined number of clusters and to cluster the local motion vectors per blocks into a cluster for which the distance calculated by the distance calculation unit is shortest.

In the representative calculation unit, an average value of local motion vectors that are obtained by affine transformation or projective transformation corresponding to the input image and are classified into clusters by the clustering unit may be calculated as a representative motion vector.

In the representative calculation unit, a vector specified by an affine transformation parameter of the local motion vectors in a cluster made by the clustering unit, or a projective transformation parameter, which is obtained by affine transformation or projective transformation corresponding to the input image, may be calculated as a representative motion vector.

A buffering unit configured to buffer the average value of the local motion vectors of each cluster made by the clustering unit, or the vector specified by the affine transformation parameter or the projective transformation parameter, which is calculated by the representative calculation unit, may be further included, and the clustering unit may cluster the local motion vectors using the average value of the local motion vectors of each cluster made by the clustering unit, or the vector specified by the affine parameter or the projective transformation parameter, which is buffered in the buffering unit, as vectors to be set for each cluster.

A merge-split unit configured to merge clusters whose locations within a vector space between clusters are close to each other among the clusters made by the clustering unit, and to split a cluster having a large variance within the vector space between clusters into a plurality of clusters may be further included.

A first down-convert unit configured to down-convert the input image into an image having a lower resolution; a second down-convert unit configured to down-convert the reference image into an image having a lower resolution; a first up-convert unit configured to apply the local motion vector per block obtained from the image having the lower resolution, when the image having the lower resolution is set to have a resolution of the input image, to the block when a resolution returns to the resolution of the input image; a second up-convert unit configured to apply the global motion vector obtained from the image having the lower resolution, when the image having the lower resolution is set to have a resolution of the input image, to the block when a resolution returns to the resolution of the input image; and a selection unit configured to select one of the local motion vector and the global motion vector with respect to the blocks of the input image by comparing a sum-of-absolute-difference between pixels per block of the input image to which a local motion vector is applied by the first up-convert unit and pixels per block of the reference image corresponding to the block, with a sum-of-absolute-difference between pixels per block of the input image to which the global motion vector is applied by the second up-convert unit and pixels per block of the reference image corresponding to the block may be further included.

According to another embodiment of the present technology, there is provided an image processing method including: detecting a local motion vector per block using block matching between an input image and a reference image, in a local motion vector detection unit configured to detect the local motion vector per block using block matching between the input image and the reference image; clustering the local motion vector per block into a predetermined number of clusters based on a distance between the local motion vector per block and a vector set for each of the predetermined number of clusters, in a clustering unit configured to cluster the local motion vector per block into the predetermined number of clusters; calculating a representative local motion vector representing each cluster made in the clustering step, in a representative calculation unit configured to calculate the representative local motion vector representing each cluster made by the clustering unit; and selecting a global motion vector of the input image from the representative local motion vectors of the respective clusters based on the number of local motion vectors in each cluster, in a global motion vector selection unit configured to select the global motion vector of the input image from the representative local motion vectors of the respective clusters based on the number of local motion vectors in each cluster.

According to another embodiment of the present technology, there is provided a program for causing a computer including an image processing device to execute processes, the image processing device including: a local motion vector detection unit configured to detect a local motion vector per block using block matching between an input image and a reference image; a clustering unit configured to cluster the local motion vector per block into a predetermined number of clusters based on a distance between the local motion vector per block and a vector set for each of the predetermined number of clusters; a representative calculation unit configured to calculate a representative local motion vector representing each cluster made by the clustering unit; and a global motion vector selection unit configured to select a global motion vector of the input image from the representative local motion vectors of the respective clusters based on the number of local motion vectors in each cluster, and the processes including, detecting the local motion vector per block using block matching from the input image and the reference image, in the local motion vector detection unit; clustering the local motion vector per block into the predetermined number of clusters based on the distance between the local motion vector per block and a vector set for each of the predetermined number of clusters, in the clustering unit; calculating the representative local motion vector representing each cluster made in the clustering step, in the representative calculation unit; and selecting a global motion vector of the input image from the representative local motion vectors of the respective clusters based on the number of local motion vectors in each cluster, in the global motion vector selection unit.

The program stored in the recording medium of the present technology is a computer-readable recording medium.

According to another embodiment of the present technology, there is provided an image processing device including: a local motion vector detection unit configured to detect a local motion vector per block using block matching between an input image and a reference image; a clustering unit configured to cluster the local motion vector per block for each of a predetermined number of objects based on a distance between the local motion vector per block and a vector set for each of the predetermined number of objects; and an object motion vector calculation unit configured to calculate an object motion vector based on the local motion vector for each of the objects classified by the clustering unit.

The image processing device may further include: a global motion vector selection unit configured to select a global motion vector of the input image from the calculated object motion vectors based on the local motion vector clustered for each of the objects.

According to another embodiment of the present technology, there is provided an image processing method including: detecting a local motion vector per block using block matching from an input image and a reference image, in a local motion vector detection unit configured to detect a local motion vector per block using block matching between the input image and the reference image; clustering the local motion vector per block for each of a predetermined number of objects based on a distance between the local motion vector per block and a vector set for each of the predetermined number of objects, in a clustering unit configured to cluster the local motion vector per block for each of the predetermined number of objects based on the distance between the local motion vector per block and the vector set for each of the predetermined number of objects; and calculating an object motion vector based on the local motion vector for each of the objects classified by the clustering unit, in an object motion vector calculation unit configured to calculate the object motion vector based on the local motion vector for each of the objects classified by the clustering unit.

According to another embodiment of the present technology, there is provided a program for causing a computer including an image processing device to execute processes, the image processing device including: a local motion vector detection unit configured to detect a local motion vector per block using block matching between an input image and a reference image; a clustering unit configured to cluster the local motion vector per block for each of a predetermined number of objects based on a distance between the local motion vector per block and a vector set for each of the predetermined number of objects; and an object motion vector calculation unit configured to calculate an object motion vector based on the local motion vector for each of the objects classified by the clustering unit, the processes including, detecting a local motion vector per block using block matching from an input image and a reference image, in the local motion vector detection unit configured to detect the local motion vector per block using block matching between the input image and the reference image; clustering the local motion vector per block for each of the predetermined number of objects based on the distance between the local motion vector per block and the vector set for each of the predetermined number of objects, in a clustering unit configured to cluster the local motion vector per block for each of the predetermined number of objects based on the distance between the local motion vector per block and the vector set for each of the predetermined number of objects; and calculating an object motion vector based on the local motion vector for each of the objects classified by the clustering unit, in an object motion vector calculation unit configured to calculate the object motion vector based on the local motion vector for each of the objects classified by the clustering unit.

The program stored in the recording medium of the present technology is a computer-readable recording medium.

According to the embodiment of the present technology, local motion vectors per blocks of an input image are organized into a predetermined number of clusters, a representative local motion vector is set for each of the clusters, and a global motion vector of the input image is selected from the representative local motion vectors for each of the predetermined number of clusters.

According to the embodiment of the present technology, local motion vectors per blocks are detected using block matching between an input image and a reference image, the local motion vectors per blocks are organized into a predetermined number of clusters based on a distance between the local motion vector per block and a vector set for each of the predetermined number of clusters, a representative local motion vector representing each of the classified clusters is calculated, and a global motion vector of the input image is selected from the representative local motion vectors of the respective clusters based on the number of local motion vectors in each of the clusters.

According to the embodiment of the present technology, local motion vectors per blocks are detected using block matching between an input image and a reference image, the local motion vectors per blocks are clustered for each of a predetermined number of objects based on a distance between the local motion vector per block and a vector set for each of the predetermined number of objects, and an object motion vector is calculated based on the local motion vector for each of the classified objects.

The image processing device of the present technology may be a stand-alone device, and may also be a block that carries out an image process.

According to embodiments of the present technology, it is possible to more accurately detect motion vectors from an image.

### BRIEF DESCRIPTION OF THE DRAWINGS

FIG. 1 is a block diagram illustrating an example configuration of a first embodiment of an image coding device to which an image processing device of the present technology is applied;

FIG. 2 is a diagram illustrating an example configuration of a motion vector detection unit of FIG. 1;

FIG. 3 is a diagram illustrating an example configuration of a global motion vector (GMV) detection unit of FIG. 1;

FIG. 4 is a diagram illustrating an example configuration of a clustering unit of FIG. 1;

FIG. 5 is a diagram illustrating an example configuration of an average value calculation unit of FIG. 1;

FIG. 6 is a flowchart illustrating a coding process in an image coding device of FIG. 1;

FIG. 7 is a flowchart illustrating a GMV detection process in a GMV detection unit of FIG. 1;

FIG. 8 is a diagram illustrating a process of a clustering unit;

FIG. 9 is a diagram illustrating a process of an average value calculation unit;

FIG. 10 is a diagram illustrating a process of a GMV determination unit;

FIG. 11 is a diagram illustrating a process of a merge-split unit;

FIG. 12 is a block diagram illustrating an example configuration of a GMV detection unit in accordance with a second embodiment of an image coding device;

FIG. 13 is a flowchart illustrating a GMV detection process in the GMV detection unit of FIG. 12;

FIG. 14 is a diagram illustrating a fallback mode;

FIG. 15 is a diagram illustrating a fallback mode;

FIG. 16 is a diagram illustrating a method of obtaining a GMV vector when a captured image is rotated;

FIG. 17 is a block diagram illustrating an example configuration of a GMV detection unit in accordance with a third embodiment of an image coding device;

FIG. 18 is a flowchart illustrating a GMV detection process in the GMV detection unit of FIG. 17;

FIG. 19 is a diagram illustrating a GMV detection process using affine transformation of the GMV detection unit of FIG. 17;

FIG. 20 is the diagram illustrating a GMV detection process using affine transformation of a GMV detection unit of FIG. 17;

FIG. 21 is a diagram illustrating an example when weighting is applied based on motion vector magnitude in a GMV detection process using affine transformation in the GMV detection unit of FIG. 17;

FIG. 22 is a diagram illustrating a GMV detection process using projective transformation of the GMV detection unit of FIG. 17;

FIG. 23 is a block diagram illustrating an example configuration of a fourth embodiment of an image coding device;

FIG. 24 is a flowchart illustrating a coding process in an image coding device of FIG. 23;

FIG. 25 is a diagram illustrating an example in which motion vectors of respective objects are different from each other;

FIG. 26 is a block diagram illustrating an example configuration of a fifth embodiment of an image coding device;

FIG. 27 is a diagram illustrating an example configuration of an object MV detection unit of FIG. 26;

FIG. 28 is a flowchart illustrating a coding process in an image coding device of FIG. 26;

FIG. 29 is a flowchart illustrating an object MV detection process in the object MV detection unit of FIG. 27;

FIG. 30 is a block diagram illustrating an example configuration of a sixth embodiment of an image coding device;

FIG. 31 is a flowchart illustrating a coding process in an image coding device of FIG. 30; and

FIG. 32 is a diagram illustrating an example configuration of a general purpose computer.

### DETAILED DESCRIPTION OF THE EMBODIMENT(S)

Hereinafter, preferred embodiments of the present technology will be described in detail with reference to the appended drawings. Note that, in this specification and the appended drawings, structural elements that have substantially the same function and structure are denoted with the same reference numerals, and repeated explanation of these structural elements is omitted.

Hereinafter, forms for embodying the present technology (which will be referred to as embodiments) will be described, in the following order:
1. First embodiment
2. Second embodiment (image coding device in a fallback mode)
3. Third embodiment (image coding device corresponding to affine or projective transformation)
4. Fourth embodiment (image coding device having a selection unit with a zero vector as a choice)
5. Fifth embodiment (image coding device that has a selection unit with a zero vector as a choice and obtains object motion vectors)
6. Sixth embodiment (image coding device having a zero vector in object motion vector as a choice)

### 1.First Embodiment

### [Image Coding Device]

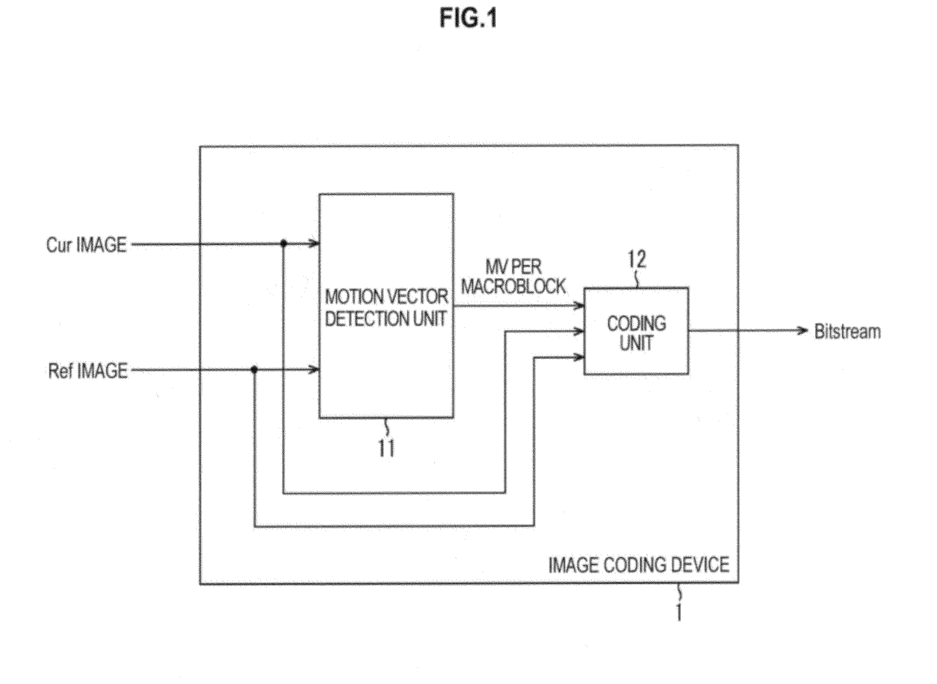

FIG. 1 illustrates an example configuration of the first embodiment of the hardware of the image coding device to which an image processing device of the present technology is applied. The image coding device 1 sequentially receives an image (current (Cur) image) to be processed in a moving image and a reference image (reference (Ref) image) corresponding to the Cur images. The image coding device 1 then obtains motion vectors per macroblocks using the Cur image and the Ref image and codes the moving image using the obtained motion vectors per macroblocks.

In further detail, the image coding device 1 includes a motion vector detection unit 11 and a coding unit 12. The motion vector detection unit 11 detects the motion vector per macroblock from the Cur image using the Cur image and the Ref image, and supplies the detected motion vector to the coding unit 12.

The coding unit 12 codes the Cur image based on the motion vector per macroblock supplied from the motion vector detection unit 11, the Cur image, and the Ref image, and supplies the coded Cur image as a bitstream.

### [Motion Vector Detection Unit]

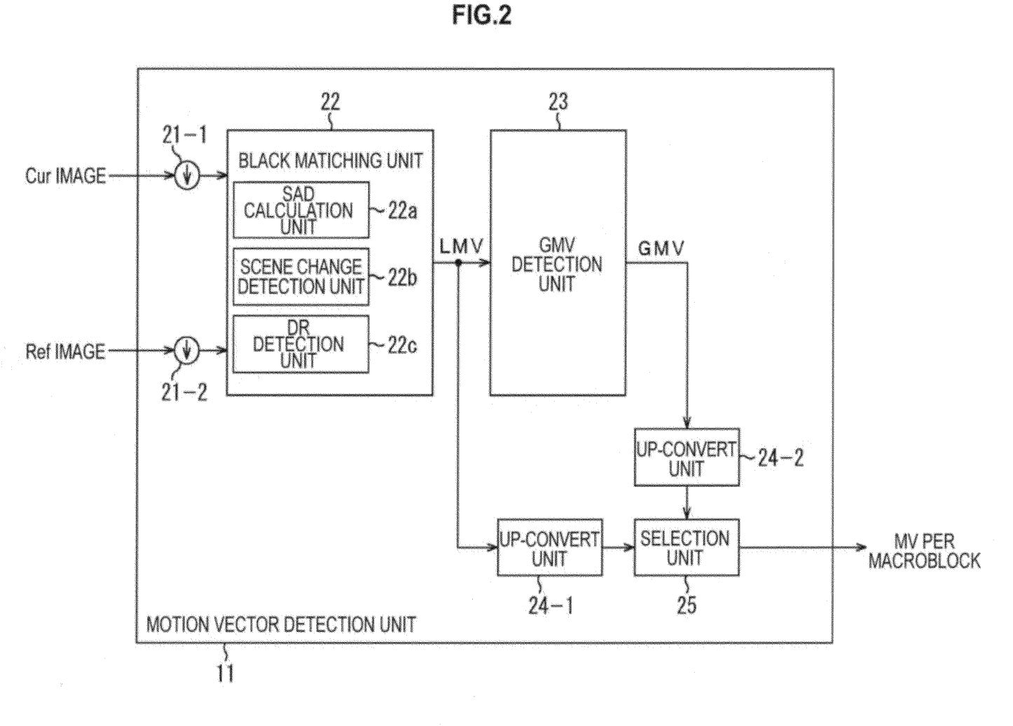

Next, an example configuration of the motion vector detection unit 11 will be described with reference to FIG. 2.

The motion vector detection unit 11 includes down-convert units 21-1 and 21-2, a block matching unit 22, a GMV (Global Motion Vector) detection unit 23, up-convert units 24-1 and 24-2, and a selection unit 25. The down-convert units 21-1 and 21-2 cause the Cur image and the Ref image to have the same low resolutions, respectively, and supply the Cur image and the Ref image to the block matching unit 22. In addition, when it is not necessary to distinguish between the down-convert units 21-1 and 21-2, the down-convert units 21-1 and 21-2 are simply referred to as a down-convert unit 21, which is also applied to the other configurations in the same way. In addition, the technique of causing the down-convert unit 21 to have a low resolution may be applied to not only thinning out of the number of pixels per row and column units but also thinning out per number of pixels in horizontal and vertical directions. In addition, thinning out may be performed after a low pass filter (LPF) is applied.

The block matching unit 22 divides each of the Cur image and the Ref image into macroblocks, each having m pixels×m pixels, and searches for matching blocks by comparing each macroblock of the Cur image with each macroblock of the Ref image. The block matching unit 22 then obtains the vector derived from a relation between the block location of the Cur image and the block location of the Ref image as a motion vector of the macroblock of the Cur image. The block matching unit 22 obtains the motion vectors of all macroblocks of the Cur image in the same way, and supplies the obtained motion vectors to the GMV detection unit 23 and the up-convert unit 24-1 as local motion vectors (LMVs) per macroblocks.

In addition, the block matching unit 22 includes a sum-of-absolute-difference (SAD) calculation unit 22a, a scene change detection unit 22b, and a dynamic range (DR) detection unit 22c. The SAD calculation unit 22a calculates an SAD between pixels in corresponding macroblocks in the Cur image and the Ref image. The scene change detection unit 22b detects whether or not the scene is changed based on the SAD between pixels in the corresponding Cur image and the Ref image and outputs the detection result as a scene change flag (SCF). The DR detection unit 22c detects the DR in pixel value of the pixels in each block, that is, an absolute difference between the minimum value and the maximum value. The block matching unit 22 outputs information such as LMV, DR, SAD, and SCF along with coordinates of each block and a frame number of the Cur image. In addition, hereinafter, the global motion vector, the local motion vector, the sum-of-absolute-difference, the scene change flag, and the dynamic range are simply referred to as GMV, LMV, SAD, SCF, and DR, respectively. In addition, a macroblock is simply referred to as a block, so, for example, units of blocks means units of macroblocks.

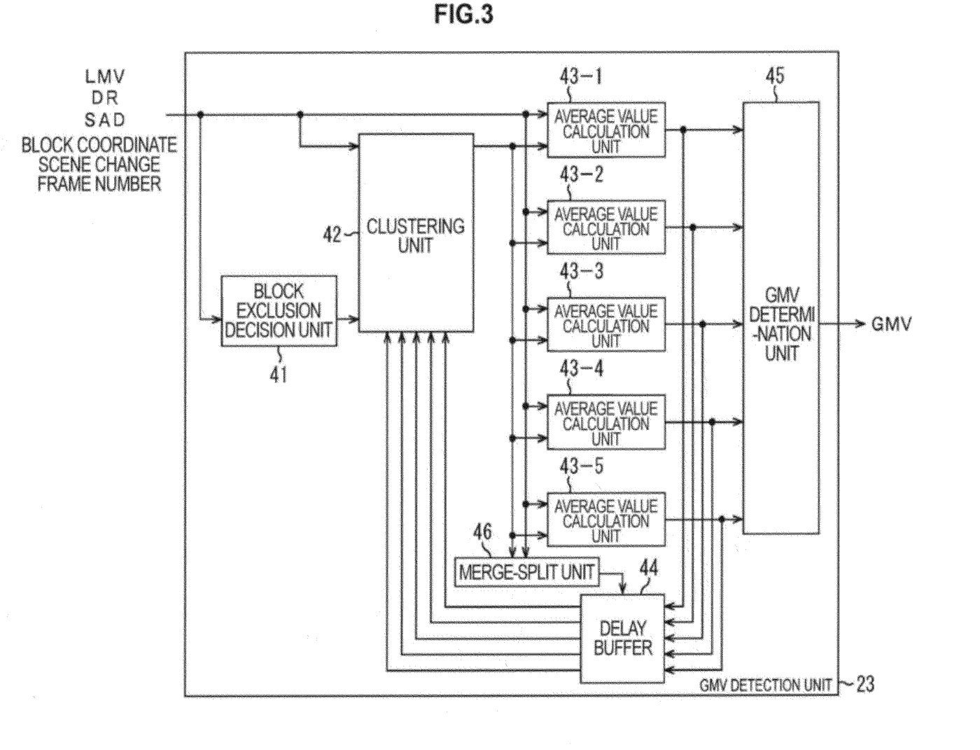

The GMV detection unit 23 detects the GMV, which is a motion vector per block of the entire Cur image based on the LMVs obtained per blocks and supplied from the block matching unit 22, and supplies the GMV to the up-convert unit 24-2. In addition, the GMV detection unit 23 will be described below in further detail with reference to FIG. 3.

The up-convert units 24-1 and 24-2 up-convert the LMVs obtained per blocks and the GMV to resolution information having the resolution corresponding to the down-convert units 21-1 and 21-2, respectively, and supply the information to the selection unit 25.

The selection unit 25 compares the supplied motion vectors per blocks as the LMVs and the supplied motion vector per block as the GMV for comparison based on the obtained sum-of-absolute-transformed-difference (SATD) obtained from the motion vectors and the information in an overhead portion at the time of coding, and outputs the selected motion vectors as motion vectors per blocks. Here, SATD is a value obtained by Hadamard-converting predictive errors of pixel values between pixels per block whose Cur image is transformed based on the motion vector and pixels per block of the corresponding Ref image, and calculating a sum of absolute values of the predictive errors.

### [GMV Detection Unit]

Next, an example configuration of the GMV detection unit 23 will be described with reference to FIG. 3.

The GMV detection unit 23 includes a block exclusion decision unit 41, a clustering unit 42, average value calculation units 43-1 to 43-5, a delay buffer 44, a GMV determination unit 45, and a merge-split unit 46.

The block exclusion decision unit 41 decides whether or not a block needs to be obtained as the LMV based on information such as DR, SAD, and block coordinates of blocks along with the LMV supplied from the block matching unit 22. In further detail, when the DR is smaller than a predetermined level and thus the block is regarded as a flat block, the block cannot be correctly obtained as the LMV, and so the block exclusion decision unit 41 regards the block as an exclusion block that does not need to be obtained as the LMV. In addition, when an SAD between pixels of the corresponding block and the block of the Ref image is greater than a predetermined threshold value based on the motion vector having a large SAD, and the motion vector is regarded as incorrect, the block exclusion decision unit 41 regards the block as an exclusion block. In addition, when a coordinate of the block is near an end of the frame image, the block exclusion decision unit 41 regards the block as an exclusion block because of a high possibility that the block was incorrectly obtained.

When the DR is smaller than a predetermined level, the SAD is greater than a predetermined threshold value, or a coordinate of the block is near an end of the frame image, the block exclusion decision unit 41 then regards the block as a block where the motion vector is not obtained, that is, an exclusion block, and outputs the corresponding flag. In addition, the other blocks are not exclusion blocks, and thus the block exclusion decision unit 41 outputs a flag indicating that the other blocks are blocks where motion vectors need to be obtained. In addition, when the block exclusion decision unit 41 decides whether or not the block is flat, values of the DR may be used as described above, however, parameters other than the DR may be used as long as it can be decided whether or not the block is flat. For example, variance may be used or both variance and DR may be used for the determination.

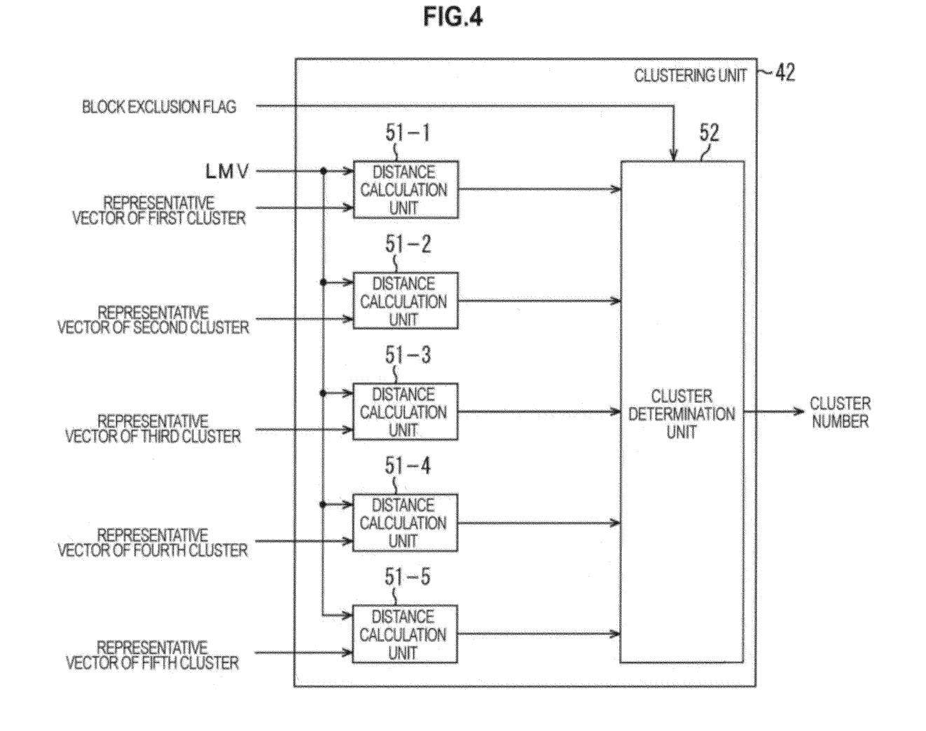

The clustering unit 42 calculates a distance between the LMV of the block determined not to be the exclusion block in the block exclusion decision unit 41 and a representative vector of each of a predetermined number of clusters buffered in the delay buffer 44. The clustering unit 42 then clusters (classifies) motion vectors into a cluster to which the closest vector belongs based on the obtained distance information, and supplies the determined cluster information along with the LMV to the average value calculation units 43-1 to 43-5 and the merge-split unit 46. In addition, an example configuration of the clustering unit 42 will be described later in detail with reference to FIG. 4.

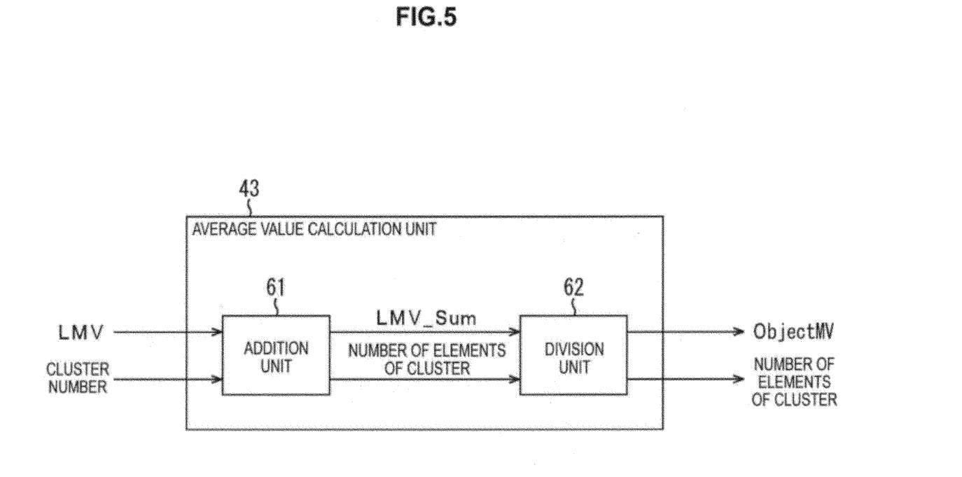

The average value calculation units 43-1 to 43-5 acquire information indicating the cluster and the LMV, and also store LMVs only corresponding to the clusters belonging to the respective average value calculation units. In addition, the average value calculation units 43-1 to 43-5 calculate average values of respective LMVs belonging to the clusters of the respective average value calculation units as respective representative vectors, and supply the average values along with information such as a number of elements of LMVs to the GMV determination unit 45 and the delay buffer 44. In addition, a configuration of the average value calculation unit 43 will be described below in detail with reference to FIG. 5.

The delay buffer 44 buffers the representative vectors composed of average values of each cluster supplied from the average value calculation unit 43 at first, and then supplies the representative vectors to the clustering unit 42 at a subsequent time as representative vectors of each cluster.

The GMV determination unit 45 determines the GMV based on the average values of respective clusters supplied from the respective average value calculation units 43-1 to 43-5, that is, information of representative vectors, and the number of elements of the LMV of each cluster that are used to calculate the averages values. The GMV determination unit 45 then outputs the determined representative vector of the cluster as the GMV.

The merge-split unit 46 merges (combines) a plurality of clusters from the distributed LMVs as the elements of the cluster or splits one cluster into a plurality of clusters based on a variance or covariance of the LMVs of each cluster. The merge-split unit 46 changes the representative vector of each cluster buffered in the delay buffer 44 based on the information of the merged or split clusters. That is, the merge-split unit 46 obtains an average value based on the LMVs belonging to the new cluster generated by merging or splitting, obtains the representative vector of each of the clusters and causes the delay buffer 44 to buffer the representative vector. In addition, since splitting or merging the clusters is not an essential process, splitting or merging the clusters in the merge-split unit 46 may be omitted when processing loads need to be reduced to implement a fast process. In addition, only merging or only splitting may be carried out.

### [Clustering Unit]

Next, an example configuration of the clustering unit 42 will be described referring to FIG. 4. The clustering unit 42 includes distance calculation units 51-1 to 51-5 and a cluster determination unit 52. Each of the distance calculation units 51-1 to 51-5 obtains a distance between each of vectors composed of representative values of the first cluster to the fifth cluster and the supplied LMV, and supplies the distance to the cluster determination unit 52.

The cluster determination unit 52 determines the cluster having the shortest distance with respect to the LMV based on the distance between the LMV supplied from each of the distance calculation units 51-1 to 51-5 and the representative vector of each of the first to fifth clusters supplied from the delay buffer 44. The cluster determination unit 52 then supplies the determined cluster information to the average value calculation units 43-1 to 43-5.

### [Average Value Calculation Unit]

Next, an example configuration of the average value calculation unit 43 will be described with reference to FIG. 5. The average value calculation unit 43 includes an addition unit 61 and a division unit 62.

The addition unit 61 adds the LMV that is classified into the cluster of the addition unit among the supplied LMVs in an accumulative way, and supplies the added result LMV_sum to the division unit 62. Here, the addition unit also supplies information including the accumulated number of LMVs (the number of elements of LMVs belonging to the cluster) to the division unit 62. The division unit 62 divides the added result LMV_sum by the number of elements of LMVs to obtain a motion vector having an average value of the cluster as a representative vector of the cluster, that is, as a motion vector that is a candidate of GMV to be described later. The division unit 62 then supplies the calculated representative vector and information of the number of elements of the cluster to the GMV determination unit 45 and the delay buffer 44.

### [Coding Process]

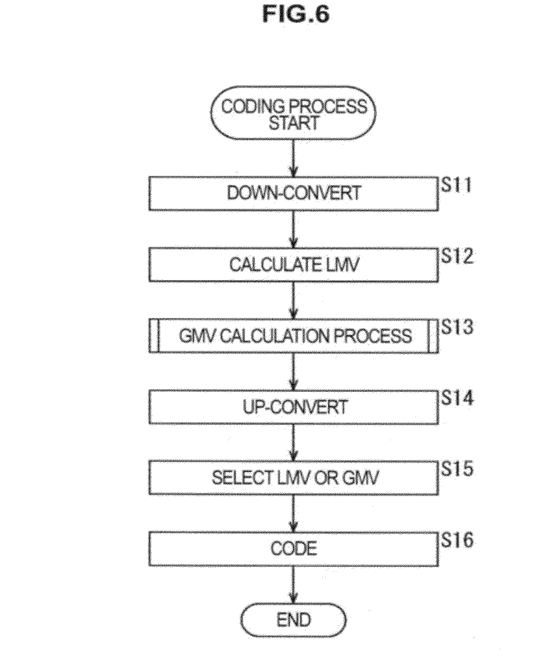

Next, a coding process of the image coding device 1 of FIG. 1 will be described with reference to a flowchart of FIG. 6.

In step S11, when the image having the frame number to be processed and the Ref image are supplied, the down-convert units 21-1 and 21-2 of the motion vector detection unit 11 down-convert the respective images to images having a lower resolution. In addition, a predictive picture (P picture) is used as the Ref image corresponding to the Cur image.

In step S12, the block matching unit 22 carries out a block matching process to detect an LMV per macroblock in the Cur image, and supplies the detected LMV to the GMV detection unit 23 and the up-convert unit 24-1. In further detail, the block matching unit 22 sequentially extracts the Cur image by dividing the Cur image per macroblock, for example, of x pixels×x pixels or the like, performs comparison with macroblocks within the Ref image by matching, and obtains the most similar macroblock regarded as a matching macroblock along with the location of the macroblock. The block matching unit 22 then obtains the motion vector per macroblock in the Cur image from the location of the macroblock within the Ref image and the obtained location of the most similar macroblock regarded as the matching macroblock within the Ref image. The motion vector in the macroblock obtained in this stage is the LMV. The block matching unit 22 performs this process on all macroblocks to detect the LMV of each macroblock, and supplies the LMV to the GMV detection unit 23 and the up-convert unit 24-1.

Here, the block matching unit 22 controls the SAD calculation unit 22a to cause the SAD calculation unit 22a to calculate the SAD between pixels of each macroblock of the Cur image and each macroblock of the matched Ref image. In addition, the block matching unit 22 controls the scene change detection unit 22b to cause the scene change detection unit to detect whether or not a scene is changed between the Cur image and the Ref image and to generate a scene change flag. That is, when the scene is changed, the SAD between pixels in the entire image is largely changed, the scene change detection unit 22b then compares the SAD between pixels in the entire image with a predetermined threshold value, and generates the SCF composed of the flag indicating that the scene is changed when the SAD is greater than the predetermined threshold value. Otherwise, the scene change detection unit 22b generates the SCF indicating that the scene is not changed. The SCF may be supplied from an imaging device. In addition, the block matching unit 22 controls the DR detection unit 22c to cause the DR detection unit to generate the DR of the pixel values of the pixels in each macroblock of the Cur image. The block matching unit 22 then outputs the SAD, the SCF, and the DR to the GMV detection unit 23 and the up-convert unit 24-1 in a corresponding way with the LMV.

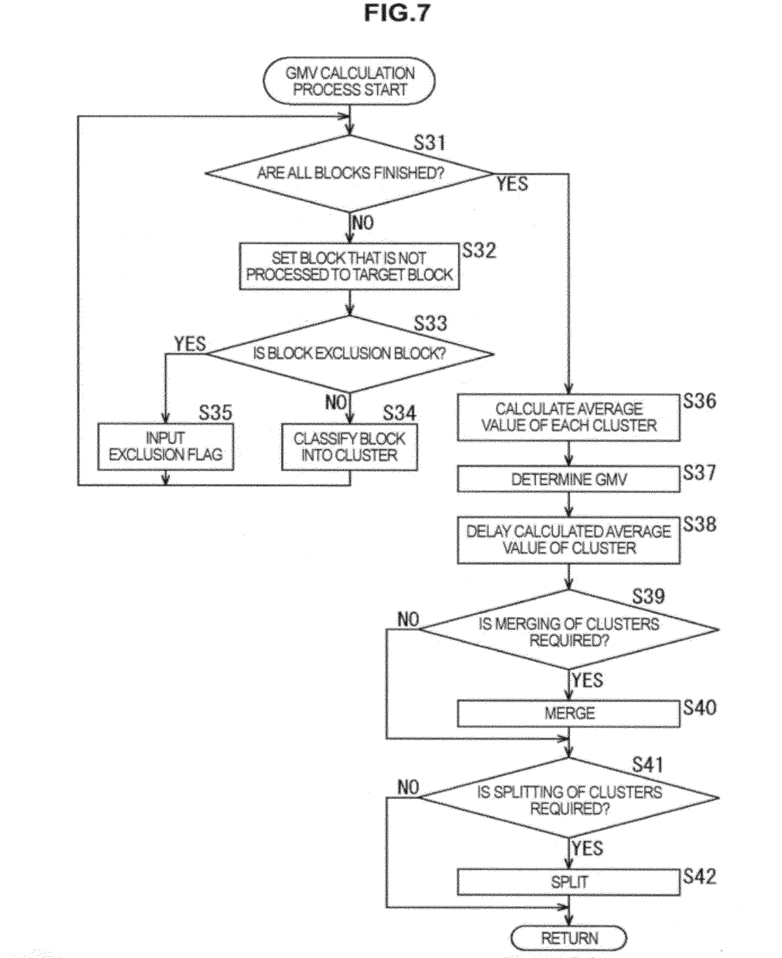

In step S13, the GMV detection unit 23 carries out the GMV detection process, obtains the GMV based on the LMV supplied from the block matching unit 22, and supplies the GMV to the up-convert unit 24-2. In addition, the GMV detection process will be described in detail with reference to a flowchart of FIG. 7.

In step S14, the up-convert units 24-1 and 24-2 up-convert the information such as LMV and GMV to information of which the resolution becomes a higher resolution of the input Cur image and the Ref image, and supplies the information to the selection unit 25.

In step S15, the selection unit 25 obtains the information of the overhead portion and the SATD at the time of using the LMV and GMV per macroblock corresponding to the resolution of the input Cur image, selects any one of the LMV and the GMV having a minimum value as a motion vector per macroblock, and outputs the selected one to the coding unit 12.

In further detail, the selection unit 25 generates the image in which each macroblock of the Cur image is moved using each of the LMV and the GMV per macroblock and obtains the SATD between pixels in the Cur and Ref images, thereby obtaining the SATD. In addition, the selection unit 25 configures the information of the overhead portion using the LMV and the GMV. The selection unit 25 then outputs the motion vector for which the SATD of each of the LMV and GMV and the information of the overhead portion are minimized as a motion vector per macroblock in the Cur mage.

In step S16, the coding unit 12 codes the Cur image using the motion vector per block along with the Cur image and the Ref image.

The Cur image is coded according to the process described above. In addition, an example of using the image of which the resolution becomes lower at the time of obtaining the LMV and the GMV by the down-convert units 21-1 and 21-2 and the up-convert units 24-1 and 24-2 has been described above. However, this process intends to reduce the processing loads and enhance the overall processing speed, however, is not an essential process so long as a hardware throughput remains. The down-convert units 21-1 and 21-2 and the up-convert units 24-1 and 24-2 are thus not essential in implementing the process described above.

### [GMV Detection Process]

Next, the GMV detection process will be described with reference to a flowchart of FIG. 7.

In step S31, the block exclusion decision unit 41 decides whether or not all blocks are processed in the Cur image. In step S31, for example, when the block to be processed remains, the process proceeds to step S32.

In step S32, the block exclusion decision unit 41 sets the block to be processed as a target block.

In step S33, the block exclusion decision unit 41 decides whether or not the target block is the macroblock to be excluded. In further detail, the block exclusion decision unit 41 regards the target block as the block to be excluded when the SAD per macroblock of the target block is greater than a predetermined threshold value, the DR is smaller than a predetermined threshold value, or a location of the target block within the image is close to an end of the Cur image. That is, when the SAD is greater than the predetermined threshold value, the change in start block and end block of the motion vector is considered to be large, so that the target block is considered to have a low reliability as the motion vector and is thus regarded as the block to be excluded. In addition, when the DR is smaller than the predetermined threshold value, the target block of the Cur image is not suitable for searching by means of block matching because the image of the target block is flat, so that the target block is regarded as the block to be excluded. In addition, when the location of the target block within the image is close to an end of the Cur image, the start block or the end block of the motion vector may be out of the frame, so that the target block is regarded as the block to be excluded.

In step S33, for example, when the target block is the block to be excluded, the process proceeds to step S34.

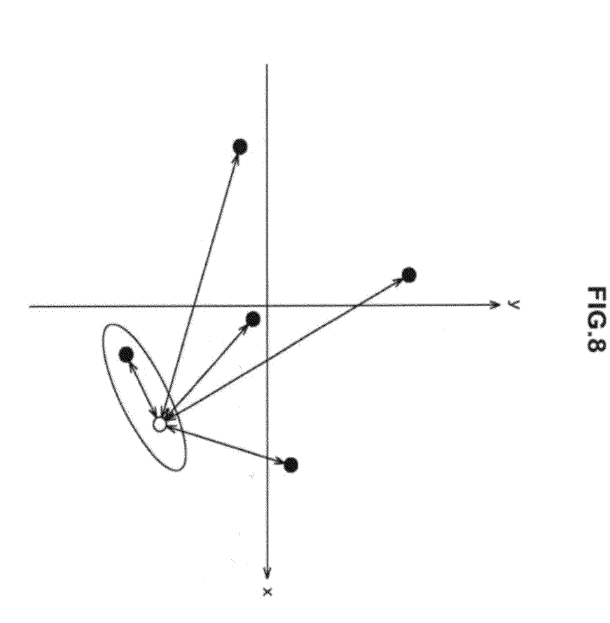

In step S34, the block exclusion decision unit 41 supplies the flag indicating that the target block is not the block to be excluded to the clustering unit 42. The clustering unit 42 classifies the LMV of the target block into the cluster, and supplies the information of the cluster to the average value calculation units 43-1 to 43-5 and the merge-split unit 46. In further detail, each of the distance calculation units 51-1 to 51-5 of the clustering unit 42, for example, calculates the distance between each of five representative vectors of each cluster indicated as black circles and supplied from the delay buffer 44 and the LMV of the target block indicated as a white circle as shown in FIG. 8, for example, using a Euclid distance or SAD, and supplies the calculated information of the distance to the cluster determination unit 52. The cluster determination unit 52 then classifies the LMV of the target block into the cluster having the representative vector of the shortest distance among the distances calculated in the respective distance calculation units 51-1 to 51-5. That is, in FIG. 8, the LMV of the target block represented as a white circle is classified into the cluster where the representative vector represented as the black circle has the shortest distance, which is surrounded by an ellipse. In addition, in the initial process, the representative vector of each cluster is not present in the delay buffer 44, and the clustering unit 42 thus classifies the motion vector of the target block into the cluster using the representative vector of each cluster set to default.

On the other hand, in step S33, when the target block is regarded as the block to be excluded, the block exclusion decision unit 41 supplies the flag indicating that the target block is a block to be excluded to the clustering unit 42. Here, the clustering unit 42 does not classify the cluster with respect to the LMV of the target block, for example, sets the value such as −1 indicating that the target block is the block to be excluded to the cluster, and supplies the value to the average value calculation units 43-1 to 43-5 and the merge-split unit 46.

The process from step S31 to step S35 is repeatedly carried out until the process is performed on all macroblocks. That is, when the process of deciding whether or not each of all macroblocks is an exclusion block and classifying all macroblocks that are not the exclusion blocks into any ones of predetermined clusters is repeatedly carried out, the process is regarded as done in step S31, and the process proceeds to step S36.

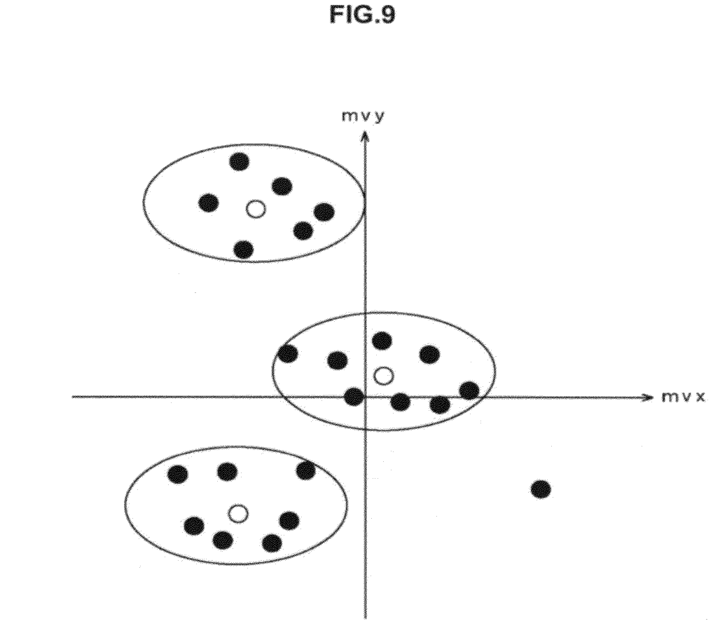

In step S36, the average value calculation units 43-1 to 43-5 calculate average values of LMVs classified into the clusters, and supply the average values to the GMV determination unit 45, respectively. In further detail, the addition unit 61 adds the LMV classified into the cluster of the addition unit among the supplied LMVs in an accumulative way, and supplies the added result LMV_sum along with the information of the number of elements of the accumulated LMV to the division unit 62. In addition, the division unit 62 obtains the motion vector having the average value of the cluster by dividing the added result LMV_sum by the number of elements as a representative vector in the cluster. The division unit 62 then supplies the representative vector obtained as the average value of LMVs of each cluster and the information of the number of elements that is the number of LMVs classified into the cluster to the GMV determination unit 45 and the delay buffer 44. That is, for example, the average value represented as a white circle is obtained as a representative vector among the LMVs represented as black circles of each cluster surrounded by an ellipse in FIG. 9.

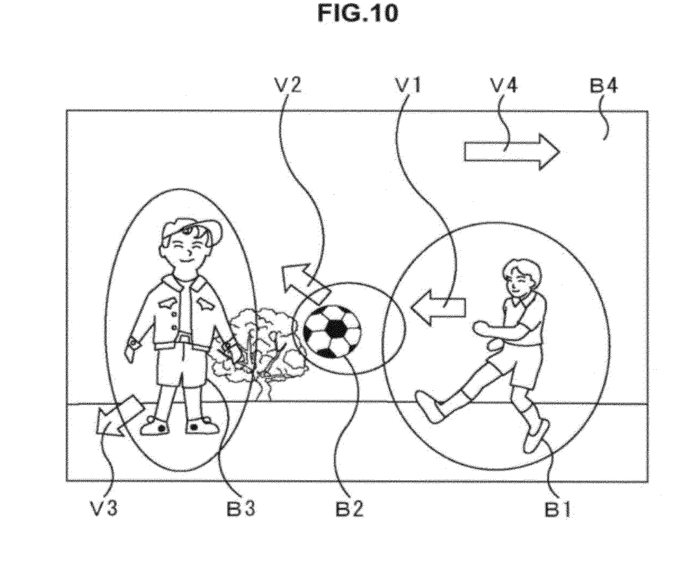

In step S37, the GMV determination unit 45 acquires the representative vector having the average value of each cluster supplied per cluster and the information of the number of elements of the cluster, and outputs the representative vector having the average value of the cluster having the largest number of elements of the cluster as the GMV. For example, as shown in FIG. 10, Cur images including the object B1 that is a person kicking the ball, the object B2 as the ball, the object B3 that is a person putting on a hat, and the object B4 as a background are considered. In the case of the Cur images of FIG. 10, the processes described above classify LMVs into clusters corresponding to the respective objects B1 to B4, obtain representative vectors of the respective clusters as motion vectors V1 to V4 corresponding to the objects B1 to B4, and supply the motion vectors to the GMV determination unit 45. The GMV determination unit 45 then determines the motion vector having the large number of elements among the motion vectors V1 to V4 of the objects obtained as the representative vectors of the respective clusters as the GMV. That is, the GMV determination unit 45 determines and outputs the representative vector that is the average value of the LMVs obtained in a corresponding way with an object that has a large number of elements within the image, that is, an object of which many macroblocks are included in a large surface area, as the GMV.

In step S38, the delay buffer 44 buffers average values of the LMVs of the clusters supplied from the average value calculation units 43-1 to 43-5 by delaying the average values as the representative vectors of the respective clusters. That is, the representative vectors of the respective clusters are average values of the LMVs of the respective clusters clustered in the immediately previous frame image.

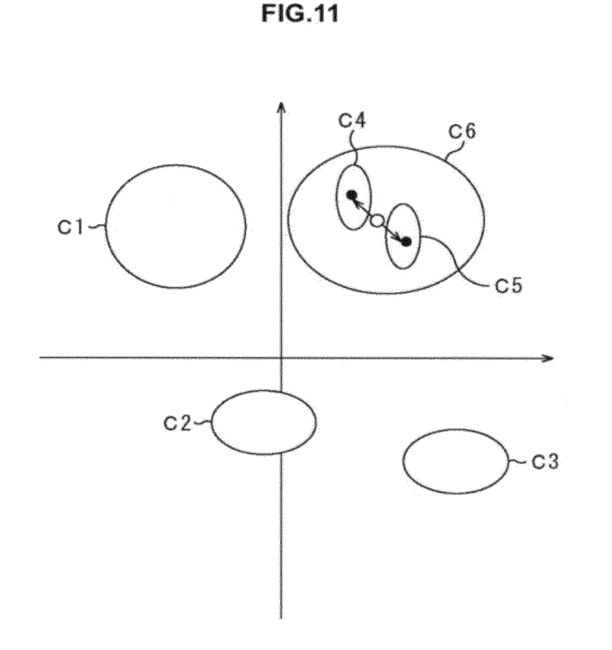

In step S39, the merge-split unit 46 decides whether or not it is necessary to merge clusters based on the variance or covariance obtained from the distribution of LMVs of the respective clusters from the clustering unit 42. That is, for example, as shown in FIG. 11, when classified clusters C1 to C5 are represented as solid lines, it is decided that merging is required when the clusters C4 and C5 need to be regarded as one cluster because the variance is small. In step S39, when it is decided that such clusters need to be merged, the process proceeds to step S40.

In step S40, the merge-split unit 46 merges the plural clusters that are recognized as being required for merging into one cluster. That is, in FIG. 11, the clusters C4 and C5 represented as solid lines are merged into one cluster C6 represented as a dotted line. Here, the merge-split unit 46 merges the LMVs belonging to the clusters C4 and C5 that are classified results of the LMVs so far, for example, obtains the average value represented as a white circle of FIG. 11, replaces representative vectors corresponding to the clusters C4 and C5 among representative vectors buffered in the delay buffer 44 with a representative vector of the cluster C6, and causes the delay buffer to buffer the replaced representative vector. As a result, in FIG. 11, clusters are classified into four kinds of clusters such as clusters C1 to C3 and the cluster C6 from then on.

In addition, in step S39, when it is decided that merging is not required, the process of step S40 is skipped.

In step S41, the merge-split unit 46 decides whether or not it is necessary to split the clusters based on the variance or covariance of the distribution of LMVs of the respective clusters from the clustering unit 42. That is, for example, as shown in FIG. 11, when there are four kinds of clusters in total such as clusters C1 to C3 and the cluster C6, splitting is required for the cluster C6 when the cluster C6 is regarded as two clusters, because of the large variance. In step S41, when it is decided that such a cluster needs to be split into plural clusters, the process proceeds to step S42.

In step S42, the merge-split unit 46 splits the cluster that is recognized as being required for splitting into plural clusters. That is, in FIG. 11, the merge-split unit 46 splits the LMVs belonging to the cluster C6 into two clusters C4 and C5 based on the distribution of LMVs belonging to the cluster C6 as shown in FIG. 11. In addition, the merge-split unit 46 obtains the average value of the LMVs belonging to the split clusters C4 and C5 using the same calculation technique as the average value calculation unit 43. The merge-split unit 46 then causes the delay buffer 44 to buffer the representative vectors of the obtained clusters C4 and C5 instead of the representative vector of the cluster C6.

According to the processes described above, it is possible to sequentially obtain GMVs in a frame image unit. In this manner, it is possible to obtain the motion vector that is a candidate of GMV by classifying the LMV per macroblock, substantially of an object, into clusters and obtaining the representative vector of each cluster, that is, per object. The representative vector having a large number of elements, that is, having a large occupying area within the image among representative vectors of the respective objects that are candidates for the GMVs, is then selected and output as the GMV.

As a result, it is possible to obtain the motion vector of the object having a large number of dominant elements within the image, that is, having a large occupying area within the image, as the GMV in the image. In addition, the above description takes the number of clusters to be five, however, the number of clusters is not limited to five and may be any other number of clusters.

### 2. Second Embodiment

### [GMV Detection Unit Having Fallback Mode]

In the description above, the representative vector, which is the average value of the LMVs in a cluster, is calculated as the candidate of GMV, and the representative vector of the cluster having the largest number of elements is selected as the GMV. However, when scene change occurs between the Cur image and the Ref image, or none of the elements of any cluster are small, it is expected that the reliability of the representative vector to be obtained or the representative vector classified into each cluster will be low. In this case, the GMV of the immediately previous image may be used as is as the GMV obtained in the Cur image, and a zero vector may be employed.

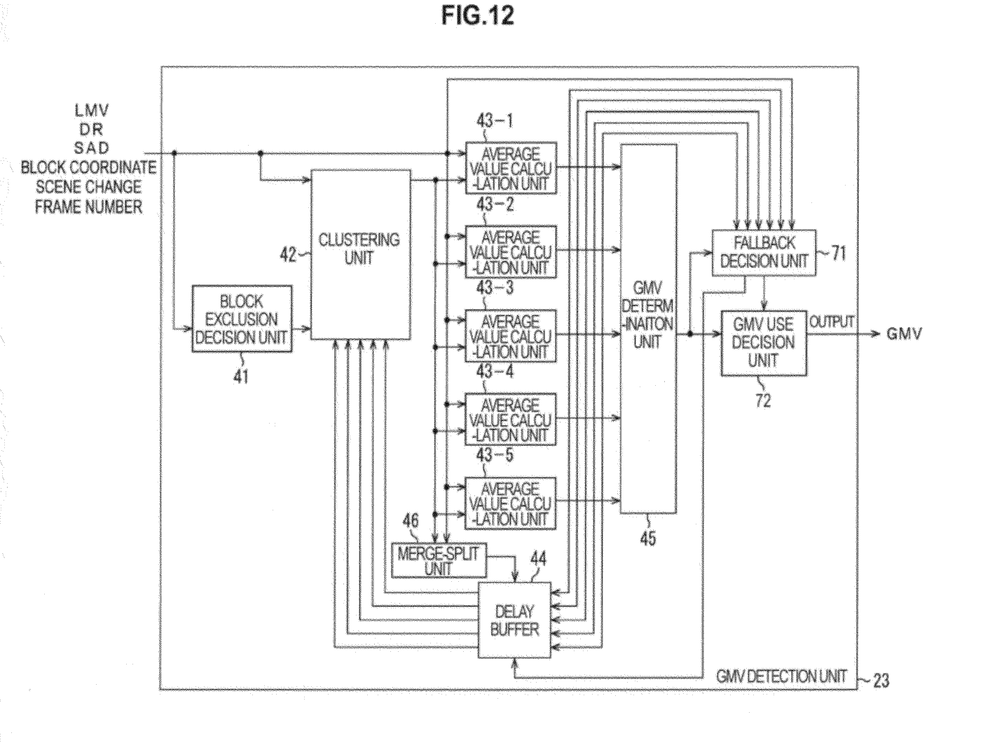

FIG. 12 illustrates an example configuration of the GMV detection unit 23 that has employed the GMV of the immediately previous image or the zero vector for the GMV when the reliability of the representative vector that is the candidate of the obtained GMV is low. In addition, hereinafter, the mode of which the reliability of the representative vector obtained of each cluster is low is referred to as a fallback mode. In addition, the fallback mode has a first pattern associated with the scene change and a second pattern associated with the decrease in number of elements per cluster.

In addition, in the GMV detection unit 23 of FIG. 12, parts of the configuration that have the same functions as in the GMV detection unit 23 of FIG. 3 are denoted with the same names and reference numerals, and redundant descriptions are appropriately omitted.

That is, the GMV detection unit 23 of FIG. 12 differs from the GMV detection unit 23 of FIG. 3 in that a fallback decision unit 71 and a GMV use decision unit 72 are additionally disposed at a subsequent stage of the GMV determination unit 45.

The fallback decision unit 71 decides whether or not the mode is the fallback mode of the first pattern based on whether the SCF indicates the scene change. In addition, the fallback decision unit 71 decides whether or not the ratio of the number of elements of the cluster having the largest number of elements to the number of macroblocks from which the number of macroblocks at an end of the image is excluded is greater than a predetermined threshold value, and decides whether or not the mode is the fallback mode of the second pattern. In addition, the fallback decision unit 71 stores the representative vector of each cluster supplied from the respective average value calculation units 43-1 to 43-5 and the GMV supplied from the GMV determination unit 45 with respect to the immediately previous one frame.

When it is decided that the mode is the fallback mode of the first pattern, the fallback decision unit 71 supplies the zero vector along with the decision result indicating the fallback mode of the first pattern to the GMV use decision unit 72. Here, the fallback decision unit 71 sets the representative vector of each cluster stored in the delay buffer 44 to an initial value. In addition, when it is determined that the mode is the fallback mode of the second pattern, the fallback decision unit 71 supplies the GMV of the immediately previous frame along with the decision result indicating the fallback mode of the second pattern to the GMV use decision unit 72. Here, the fallback decision unit 71 sets the representative vector of each cluster stored in the delay buffer 44 to a representative vector per the immediately previous cluster stored in the fallback decision unit. In addition, when the mode is not the fallback mode, the fallback decision unit 71 supplies the decision result indicating that the mode is not the fallback mode to the GMV use decision unit 72.

The GMV use decision unit 72 outputs any of the GMV supplied from the GMV determination unit 45, the GMV of the immediately previous frame image, or the zero vector based on the decision result supplied from the fallback decision unit 71. In further detail, in a case of the decision result indicating the fallback mode of the first pattern, the GMV use decision unit 72 also outputs the zero vector supplied from the fallback decision unit 71 as the GMV of the Cur image. In addition, in a case of the decision result indicating the fallback mode of the second pattern, the GMV use decision unit 72 also outputs the GMV of the immediately previous image preceding by one frame supplied from the fallback decision unit 71 as the GMV of the Cur image. In addition, in a case of the decision result that the mode is not the fallback mode, the GMV use decision unit 72 outputs the GMV supplied from the GMV determination unit 45 as the GMV of the Cur image as is.

### [GMV Calculation Process]

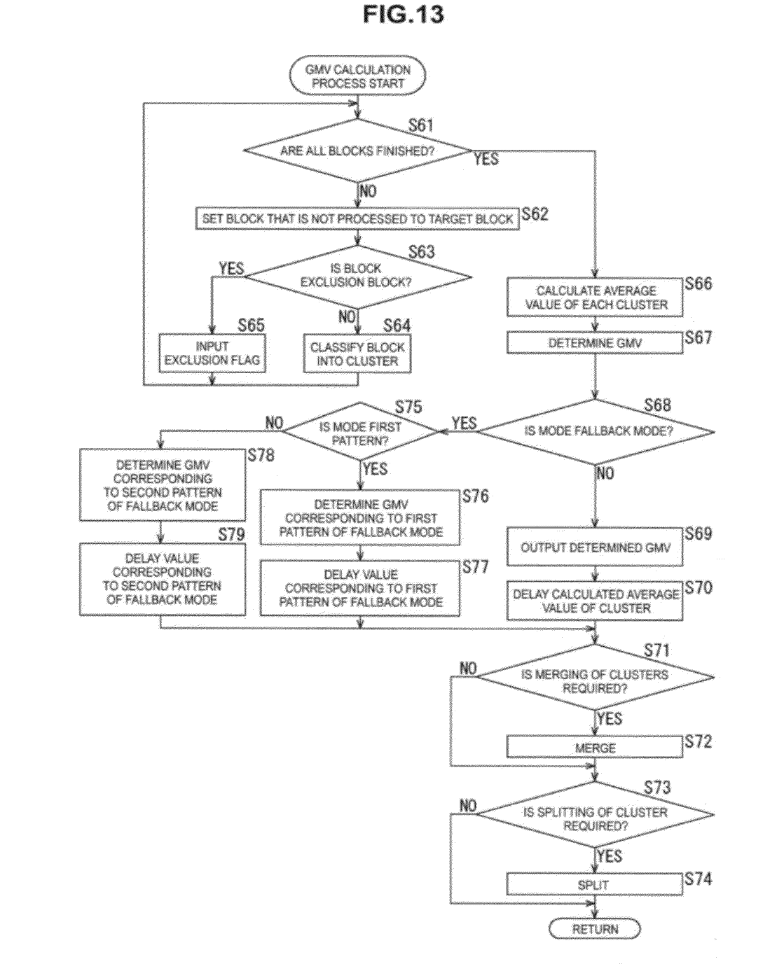

Next, the GMV calculation process in the GMV detection unit 23 of FIG. 12 will be described with reference to a flowchart of FIG. 13. In addition, the process from step S61 to S67 and S70 to S74 in the flowchart of FIG. 13 is the same as the process of step S31 to S42 described with reference to the flowchart of FIG. 7, and thus their description will not be repeated.

That is, in step S61 to step S67, it is decided whether or not each of all blocks is the exclusion block, the LMVs are clustered with respect to the macroblocks that are not the exclusion blocks, the representative vector of each cluster is obtained, and the representative vector having the largest number of elements per cluster is selected as the GMV. Here, the representative vector of each cluster is supplied to the fallback decision unit 71.

In step S68, the fallback decision unit 71 decides whether or not the mode is the fallback mode based on the presence or absence of scene change and the number of elements of the cluster of the vector determined as the GMV. In step S68, for example, when it is decided that the mode is the fallback mode, the process proceeds to step S75.

In step S75, the fallback decision unit 71 decides whether or not the mode is the fallback mode of the first pattern. In step S75, for example, when the SCF is the flag indicating the scene change, it is decided that the mode is the fallback mode of the first pattern, and the process proceeds to step S76.

In step S76, the fallback decision unit 71 supplies the zero vector to the GMV use decision unit 72 as the GMV. The GMV use decision unit 72 then outputs the zero vector as the GMV of the Cur image. That is, since the scene change occurs, the Cur image is considered to be the leading image that is continuously supplied and is highly likely to be different from the LMVs of the image that is obtained in an accumulative way, so that the process is carried out on a premise that motion is not present.

In step S77, the fallback decision unit 71 sets the representative vector stored in the delay buffer 44 to a vector having an initial value. That is, since the scene change occurs, the representative vector of each cluster that is obtained in an accumulative way and buffered in the delay buffer 44 is canceled first, and the representative vector having the initial value is set.

On the other hand, in step S75, when it is regarded that the scene change does not occur in the Cur image based on the SCF, since the ratio of the number of elements of the cluster of the vector determined as the GMV to the total number of macroblocks from which the number of macroblocks at an end of the image is subtracted is smaller than the predetermined threshold value, the mode is regarded as the fallback mode, and the process proceeds to step S78.

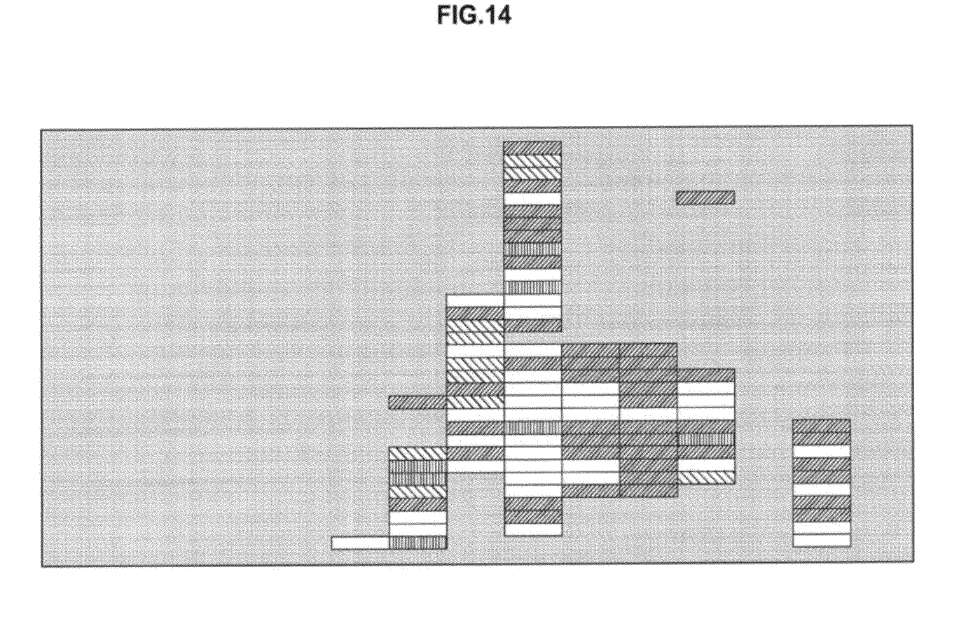

That is, for example, representative vectors of the macroblocks represented as white colors among the macroblocks set as rectangular block shapes within the Cur image shown FIG. 14 are selected as the GMVs. In this case, the ratio of the number of elements of the macroblocks represented as white colors of FIG. 14 having the largest number of elements to the total number of blocks from which the macroblocks at an end of the Cur image are subtracted is smaller than the predetermined threshold value. That is, in this case, the ratio of the number of elements of the blocks having the largest number of elements represented as white colors of FIG. 14 to the total number of blocks from which blocks close to an end of the target block are subtracted is not higher than the predetermined threshold value to regard the reliability of the GMV as a low one, so that the mode is decided as the fallback mode. In addition, the rectangular blocks are set to be disposed such that the entire image is split into macroblocks in FIG. 14, each rectangular block is denoted with a color of a cluster into which the corresponding macroblock is classified. Among these rectangular blocks, the macroblocks corresponding to the grey rectangular blocks are the exclusion blocks, and the LMVs of the macroblocks corresponding to the white rectangular blocks are ones that are classified into the clusters having the largest number of elements.

In step S78, the fallback decision unit 71 supplies the GMV of the immediately previous image that is stored to the GMV use decision unit 72. In response, the GMV use decision unit 72 outputs the GMV of the immediately previous image as the GMV of the Cur image. That is, the reliability is regarded as a low one due to the small number of elements of the representative vector classified into the cluster, the GMV of the immediately previous image having a guaranteed reliability is thus used as is to determine the GMV of the Cur image.

In step S79, the fallback decision unit 71 sets the representative vector stored in the delay buffer 44 to a representative vector obtained of each cluster in the immediately previous image that the fallback determination unit stores. That is, to determine the GMV, the reliability is regarded as a low one due to the small number of LMVs that is the number of elements for determining the representative vector classified into the cluster, and the representative vector of each cluster that is obtained in the immediately previous image is thus set as the representative vector of the delay buffer 44.

On the other hand, in step S68, when it is decided that the mode is not the fallback mode, the fallback decision unit 71 supplies the determination result indicating that the mode is not the fallback mode to the GMV use decision unit 72 in step S69. The GMV use decision unit 72 then outputs the GMV supplied from the GMV determination unit 45 as is based on the decision result. In this case, in step S70, the delay buffer 44 stores the representative vectors supplied from the average value calculation units 43-1 to 43-5 as is.

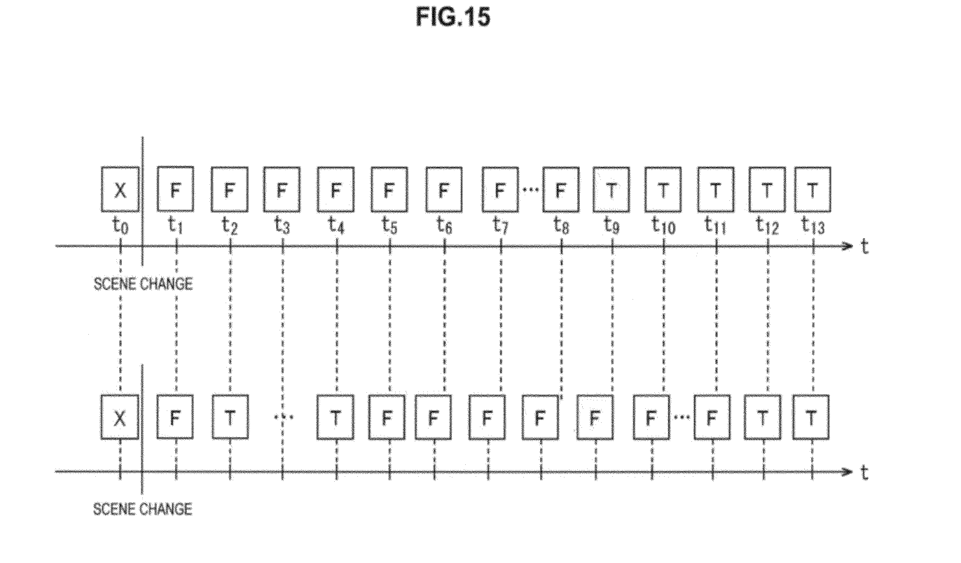

According to the processes described above, for example, as shown in an upper portion of FIG. 15, when an moving image denoted with “X” is supplied at time t0 and then an image is supplied at time t1, it is decided that the moving image is in the fallback mode of the first pattern by the scene change. In this case, the GMV is output as the zero vector, and a representative vector having an initial value is set as the representative vector of each cluster in the delay buffer 44. In addition, when the fallback mode of the second pattern is continuously detected as denoted with “F” in the upper portion of FIG. 15 in times t2 to t8, the zero vector that is the immediately previous GMV is continuously output for the duration of the times, and a representative vector having an initial value is set as the representative vector of each cluster in the delay buffer 44. When the fallback mode is not detected as denoted with “T” in the upper portion of FIG. 15 in time t9, the representative vector of each cluster sequentially obtained after the GMV obtained in each Cur image is output is stored as the representative vector of each cluster in the delay buffer 44.

In addition, for example, as shown in a lower portion of FIG. 15, when an moving image denoted with “X” is supplied at time t₀ and then an image is supplied at time t1, it is decided that the moving image is in the fallback mode of the first pattern by the scene change. In this case, the GMV is output as the zero vector, and a representative vector having an initial value is set as the representative vector of each cluster in the delay buffer 44. When the fallback mode it not detected as denoted with “T” in the lower portion of FIG. 15 in times t2 to t4, the representative vector of each cluster sequentially obtained after the GMV obtained in each Cur image is output is stored as the representative vector of each cluster in the delay buffer 44. In addition, when the fallback mode of the second pattern is continuously detected as denoted with “F” in the lower portion of FIG. 15 in times t5 to t₁₁, the GMV obtained at time t4 at which the GMV is detected is continuously output for the duration of the times, and a representative vector of each cluster obtained at time t4 is set as the representative vector of each cluster in the delay buffer 44.

At time t12, as denoted with “T” in the lower portion of FIG. 15, when the fallback mode is not detected, the representative vector having an average value of each cluster sequentially obtained after the GMV obtained in each Cur image is output is stored again as the representative vector of each cluster in the delay buffer 44 from then on.

As a result, the zero vector is used for the scene change and the GMV of the immediately previous image is subsequently used in the GMV having a low reliability, it is thus possible to select the GMV having a high reliability. In addition, the representative vector of each cluster is set to an initial value for the scene change and the representative vector of each cluster of the immediately previous image is subsequently set as is in the GMV having a low reliability, it is thus possible to more correctly perform clustering per block in an accumulative way and to correctly obtain motion vectors as candidates for the GMV, which is an average value of the LMVs of each cluster when the images having a high reliability are continued.

### 3. Third Embodiment

### [GMV Detection Unit Corresponding to Affine Transformation (Projective Transformation)]

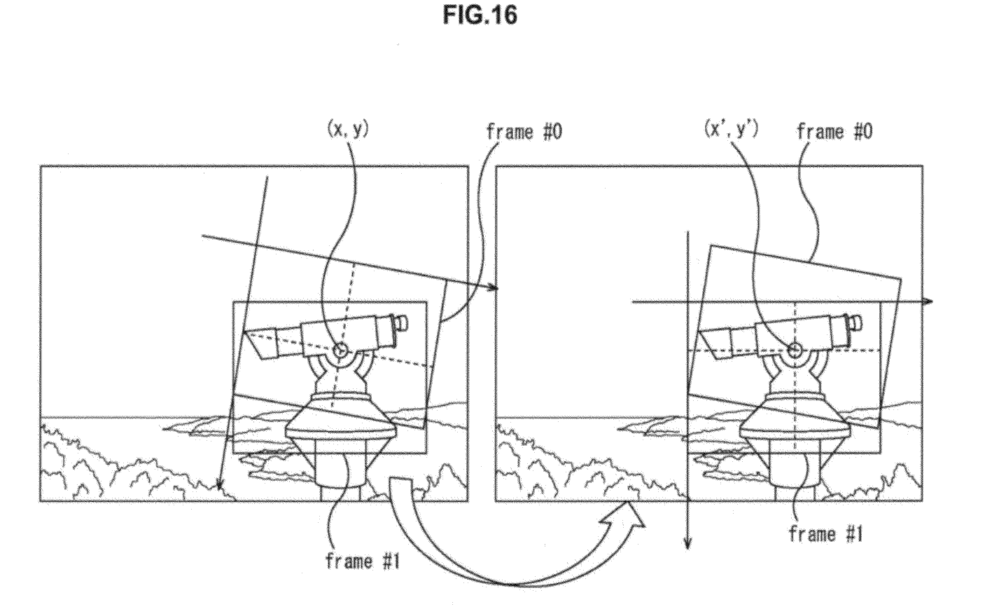

The description above has been made on the premise that an input image is captured by a fixed imaging device, however, when the imaging device performs imaging (including rotation, zoom-up, zoom-out, tilting, and so forth) while changing the imaging direction or angle, for example, when a moving image is continuously supplied such that the image frame #0 as a first image is captured and then the image frame #1 as a second image is captured as shown in FIG. 16, the motion vector may be expressed from the corresponding relation between (x′, y′) within the image frame #1 used as a reference and (x, y) within the image frame #0 or the GMV may be detected while continuously processing the images of which the imaging directions or the angles are different.

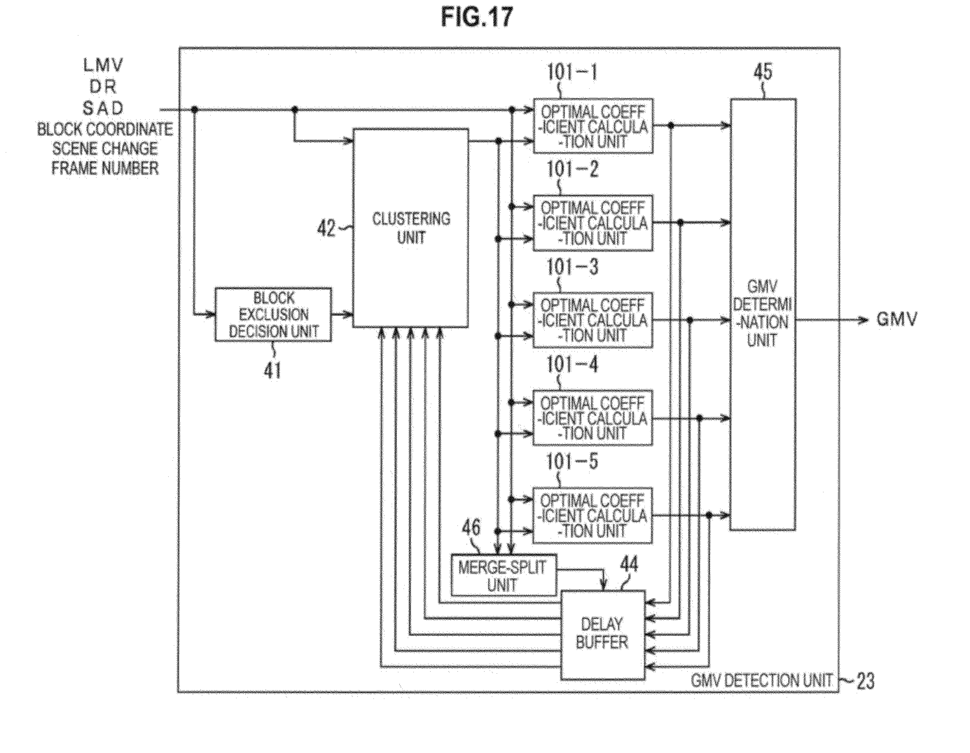

FIG. 17 illustrates an example configuration of the GMV detection unit 23 that detects the GMV while continuously processing the image from which the imaging direction or the angle is different. In addition, parts of the configuration of the GMV detection unit 23 of FIG. 17 that have the same function as in the configuration of the GMV detection unit 23 of FIG. 3 are denoted with the same reference numerals, and redundant descriptions are appropriately omitted. The GMV detection 23 of FIG. 17 differs from the GMV detection unit 23 of FIG. 3 in that optimal coefficient calculation units 101-1 to 101-5 are included instead of the average value calculation units 43-1 to 43-5.

The optimal coefficient calculation units 101-1 to 101-5 correspond to the average value calculation units 43-1 to 43-5 in the GMV detection unit 23 of FIG. 3. That is, the optimal coefficient calculation units 101-1 to 101-5 calculate translation vectors of block coordinates from optimal coefficients (initial values) of the respective clusters per block, obtain distances between the LMVs and the block coordinates, for example, using the SAD or the Euclid distance, and classify the translation vectors into the cluster having the shortest distance. The optimal coefficient calculation units 101-1 to 101-5 then output the optimal coefficients as information specifying the representative vectors.

### [GMV Detection Process in GMV Detection Unit of FIG. 17]

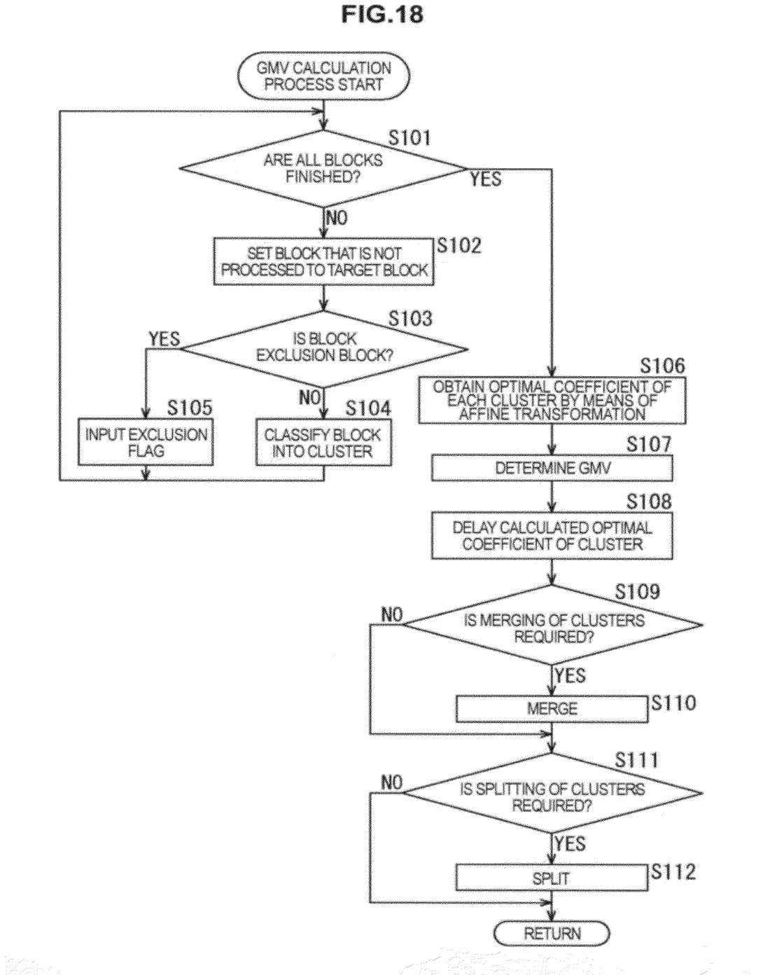

Next, the GMV detection process will be described with reference to a flowchart of FIG. 18. In addition, the processes of step S101 to step S112, excluding step S106, in the flowchart of FIG. 18 are same as the processes of step S31 to S42, excluding the process of step S36, of FIG. 7, and thus their description will not be repeated.

That is, the flowchart of FIG. 18 differs from the flowchart of FIG. 7 in that the process of calculating the optimal coefficient in step S106 is used instead of the process of calculating the average value in step S36.

### [Method of Calculating Optimal Coefficient Using Affine Transformation]

Here, the method of calculating the optimal coefficient will be described.

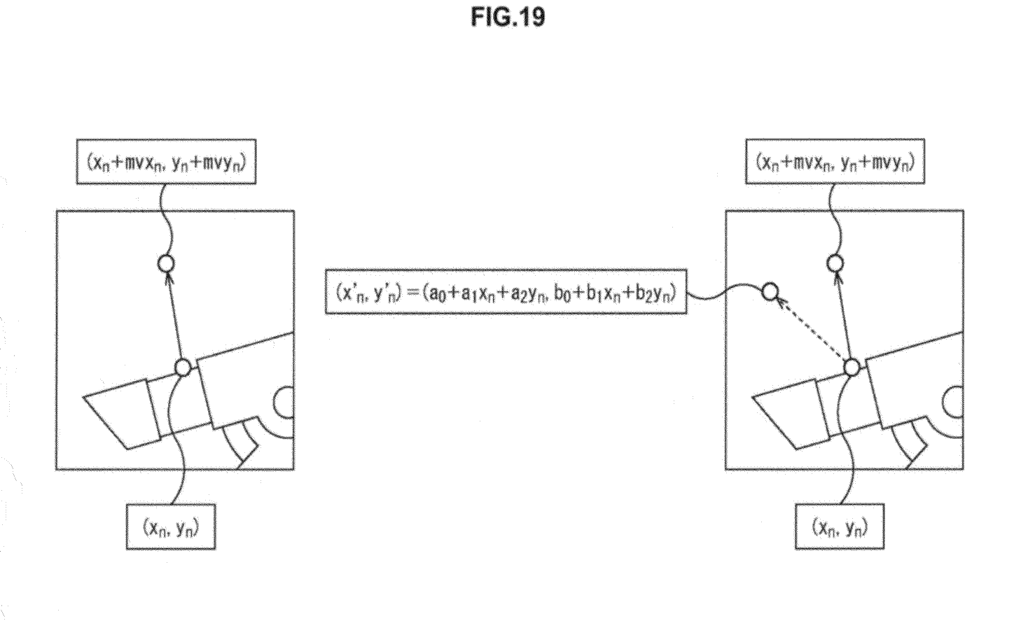

For example, as shown in a left portion of FIG. 19, when one point within the image is regarded as the reference point (xₙ, yₙ) and a motion vector at this point is a motion vector (mvxₙ, mvyₙ), the reference point (xₙ, yₙ) is expressed as a moved point (xₙ+mvxₙ, yₙ+mvyₙ) when the reference point is moved by the motion vector. In addition, n denotes the identifier that identifies each cluster.

However, it is considered that this moved point (xₙ+mvxₙ, yₙ+mvyₙ) is moved to a transformation point (x′ₙ, y′ₙ) by the motion vector represented as a dotted line when seen from a right portion of FIG. 19 by means of affine transformation. Here, x and y coordinates of the transformation point are expressed as equation (1) below.

$$\{ \begin{matrix}{x}^{′} = {a}_{0} + {a}_{1} x + {a}_{2} y \\ {y}^{′} = {b}_{0} + {b}_{1} x + {b}_{2} y\end{matrix} \qquad ( 1 )$$

Here, in equation (1), an identifier n is not denoted, and each of a₀, a₁, a₂, b₀, b₁, and b₂ indicates a coefficient when the reference point is affine-transformed to the transformation point. In addition, the coordinate at the time of performing the affine transformation is expressed with the identifier n attached in the right portion of FIG. 19. In addition, when a₂=b₁=0 and a₁=b₂=1, translation occurs.

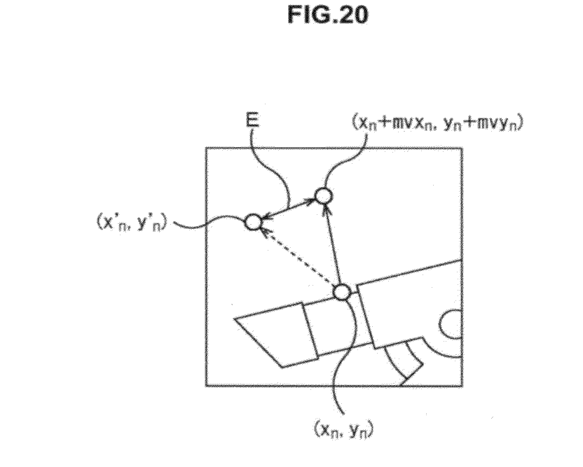

As shown in FIG. 20, an error E between the moved point (xₙ+mvxₙ, yₙ+mvyₙ) and the transformation point (x′ₙ, y′ₙ) is defined as in equation (2) below.

$$E = \sqrt{{\{ ( {a}_{0} + {a}_{1} x + {a}_{2} y ) - ( x + {mv}_{x} ) \}}^{2} + {\{ ( {b}_{0} + {b}_{1} x + {b}_{2} y ) - ( y + {mv}_{y} ) \}}^{2}} \qquad ( 2 )$$

That is, the error E is obtained as a spatial distance between the moved point (xₙ+mvxₙ, yₙ+mvyₙ) and the transformation point (x′ₙ, y′ₙ).

In addition, the cost C is defined as in equation (3) below based on the error E.

$$\begin{matrix}C = & {\sum }_{Total MB} {\{ E \}}^{2} \\ = & {\sum }_{Total MB} {\{ ( {a}_{0} + {a}_{1} {x}_{n} + {a}_{2} {y}_{n} ) - ( {x}_{n} + {mvx}_{n} ) \}}^{2} + \\ & {\{ ( {b}_{0} + {b}_{1} {x}_{n} + {b}_{2} {y}_{n} ) - ( {y}_{n} + {mvy}_{n} ) \}}^{2}\end{matrix} \qquad ( 3 )$$

Here, “total MB” indicates that the identifier n is a total sum of all macroblocks in the same cluster.

That is, the coefficients a₀, a₁, a₂, b₀, b₁, and b₂ are optimal coefficients when the cost C is a minimum value.

A simultaneous equation as in equation (4) below is obtained such that each coefficient is 0 when each coefficient is partially differentiated based on equation (3).

$$\{ \begin{matrix}\frac{\partial C}{\partial {a}_{0}} = 0 \\ \frac{\partial C}{\partial {a}_{1}} = 0 \\ \frac{\partial C}{\partial {a}_{2}} = 0 \\ \frac{\partial C}{\partial {b}_{0}} = 0 \\ \frac{\partial C}{\partial {b}_{1}} = 0 \\ \frac{\partial C}{\partial {b}_{2}} = 0\end{matrix} = \{ \begin{matrix}{\sum }_{Total MB} 2 \cdot \{ ( {a}_{0} + {a}_{1} {x}_{n} + {a}_{2} {y}_{n} ) - ( {x}_{n} + {mvx}_{n} ) \} = 0 \\ {\sum }_{Total MB} 2 \cdot \{ ( {a}_{0} + {a}_{1} {x}_{n} + {a}_{2} {y}_{n} ) - ( {x}_{n} + {mvx}_{n} ) \} \cdot {x}_{n} = 0 \\ {\sum }_{Total MB} 2 \cdot \{ ( {a}_{0} + {a}_{1} {x}_{n} + {a}_{2} {y}_{n} ) - ( {x}_{n} + {mvx}_{n} ) \} \cdot {y}_{n} = 0 \\ {\sum }_{Total MB} 2 \cdot \{ ( {b}_{0} + {b}_{1} {x}_{n} + {b}_{2} {y}_{n} ) - ( {y}_{n} + {mvy}_{n} ) \} = 0 \\ {\sum }_{Total MB} 2 \cdot \{ ( {b}_{0} + {b}_{1} {x}_{n} + {b}_{2} {y}_{n} ) - ( {y}_{n} + {mvy}_{n} ) \} \cdot {x}_{n} = 0 \\ {\sum }_{Total MB} 2 \cdot \{ ( {b}_{0} + {b}_{1} {x}_{n} + {b}_{2} {y}_{n} ) - ( {y}_{n} + {mvy}_{n} ) \} \cdot {y}_{n} = 0\end{matrix}$$

In addition, when the simultaneous equation is solved, optimal coefficients a₀, a₁, a₂, b₀, b₁, and b₂ are obtained as in equation (5) below.

$${a}_{1} = \frac{var ( {y}_{n} ) cov ( {x}_{n} , {x}_{n} + {mvx}_{n} ) - cov ( {x}_{n} , {y}_{n} ) cov ( {y}_{n} , {x}_{n} + {mvx}_{n} )}{var ( {x}_{n} ) var ( {y}_{n} ) {cov ( {x}_{n} , {y}_{n} )}^{2}} \\ {a}_{2} = \frac{var ( {x}_{x} ) cov ( {y}_{n} , {x}_{n} + {mvx}_{n} ) - cov ( {x}_{n} , {y}_{n} ) cov ( {x}_{n} , {x}_{n} + {mvx}_{n} )}{var ( {x}_{n} ) var ( {y}_{n} ) - {cov ( {x}_{n} , {y}_{n} )}^{2}} \\ {a}_{0} = \overline{{x}_{n} + {mvx}_{n}} - \overline{{x}_{n}} \cdot {a}_{1} - \overline{{y}_{n}} \cdot {a}_{2} \\ {b}_{1} = \frac{var ( {y}_{n} ) cov ( {x}_{n} , {x}_{n} + {mvy}_{n} ) - cov ( {x}_{n} , {y}_{n} ) cov ( {y}_{n} , {y}_{n} + {mvy}_{n} )}{var ( {x}_{n} ) var ( {y}_{n} ) {cov ( {x}_{n} , {y}_{n} )}^{2}} \\ {b}_{2} = \frac{var ( {x}_{x} ) cov ( {y}_{n} , {y}_{n} + {mvy}_{n} ) - cov ( {x}_{n} , {y}_{n} ) cov ( {x}_{n} , {y}_{n} + {mvy}_{n} )}{var ( {x}_{n} ) var ( {y}_{n} ) - {cov ( {x}_{n} , {y}_{n} )}^{2}} \\ {b}_{0} = \overline{{y}_{n} + {mvy}_{n}} - \overline{{x}_{n}} \cdot {b}_{1} - \overline{{y}_{n}} \cdot {b}_{2} \qquad ( 5 )$$

Here, var indicates the variance and coy indicates the covariance.

That is, in step S106, the optimal coefficient calculation units 101-1 to 101-5 calculate the coefficients a₀, a₁, a₂, b₀, b₁, and b₂ as optimal coefficients for each cluster using the techniques described above. That is, the optimal coefficient calculation units 101-1 to 101-5 calculate vectors of respective block locations from the optimal coefficient values and the block locations (coordinates of blocks), output the optimal coefficient values as representative values (optimal coefficients) of the clusters, and cause the delay buffer 44 to buffer the optimal coefficient values.

[Method of Calculating Optimal Coefficient using Weighted Affine Transformation]

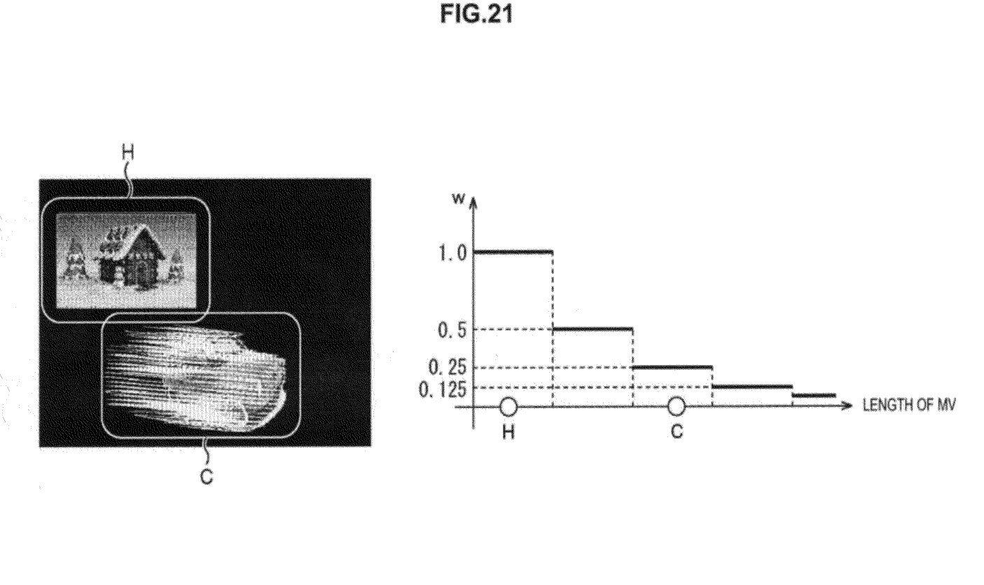

In addition, the representative vector of each cluster is the object motion vector within the Cur image as described above. The motion vector is thus obtained by a homogeneous process per object in the processes described above. However, for example, it is considered that an object H such as a house that has no motion and an object C such as a car that has motion within the flat image are present, as shown in a left portion of FIG. 21. In this case, when the process is equally applied to such objects, an image failure may occur because the image of the object H having no motion is processed using the representative vector of the object C having motion when the representative vector of the object C having motion is employed. In this case, weighting may be applied to evaluation of the representative vector in response to the magnitude of the motion, and the motion vector of the object H having no motion may be given a priority than the motion vector of the object C having large motion.

The right portion of FIG. 21 illustrates a case in which weighting is set in accordance with a magnitude of the motion vector that is a representative of each cluster, that is, the object motion vector. That is, the right portion of FIG. 21 plots the length of the representative vector MV along a horizontal axis and the magnitude of weighting w along a vertical axis. According to this, the weighting w is set to 1.0 when the length of the representative vector MV is in a range of 0 to L, 0.5 when the length of the representative vector MV is in a range of L to 2 L, 0.25 when the length of the representative vector MV is in a range of 2 L to 3 L, and 0.125 when the length of the representative vector MV is in a range of 3 L to 4 L. That is, as shown in the image of the right portion of FIG. 21, for example, the cost C is set as in equation (6) below in the techniques described above with respect to the representative vector of each of the object H such as a house having no motion and the object C such as a car having motion within the flat image.

$$C = {\sum }_{n = ( ! FLAT ) \&\& ( ! SAD LARGE )} {\{ ( {a}_{0} + {a}_{1} {x}_{n} + {a}_{2} {y}_{n} ) - ( {x}_{n} + {mvx}_{n} ) \}}^{2} + {\{ ( {b}_{0} + {b}_{1} {x}_{n} + {b}_{2} {y}_{n} ) - ( {y}_{n} + {mvy}_{n} ) \}}^{2} \qquad ( 6 )$$

However, when the weighting w is set as in the right portion of FIG. 21, the cost C is set as in equation (7) below.

$$C = {\sum }_{n = ( ! FLAT ) \&\& ( ! SAD LARGE )} {w}_{n} {\{ ( {a}_{0} + {a}_{1} {x}_{n} + {a}_{2} {y}_{n} ) - ( {x}_{n} + {mvx}_{n} ) \}}^{2} + {\{ ( {b}_{0} + {b}_{1} {x}_{n} + {b}_{2} {y}_{n} ) - ( {y}_{n} + {mvy}_{n} ) \}}^{2} \qquad ( 7 )$$

Here, wₙ indicates the weighting set based on the magnitude of the representative vector of each cluster, that is, per object.

In the case of equation (7), coefficients a₀, a₁, a₂, b₀, b₁, and b₂ as in equation (8) below are calculated by minimizing the cost C.

$${a}_{1} = \frac{{var}_{w} ( {w}_{n} , {y}_{n} ) {cov}_{w} ( {w}_{n} , {x}_{n} , {x}_{n} + {mvx}_{n} ) - {cov}_{w} ( {w}_{n} , {x}_{n} , {y}_{n} ) {cov}_{w} ( {w}_{n} , {y}_{n} , {x}_{n} + {mvx}_{n} )}{{var}_{w} ( {w}_{n} , {x}_{n} ) {var}_{w} ( {w}_{n} , {y}_{n} ) - {{cov}_{w} ( {w}_{n} , {x}_{n} , {y}_{n} )}^{2}} \\ {a}_{2} = \frac{{var}_{w} ( {w}_{n} , {x}_{x} ) {cov}_{w} ( {w}_{n} , {y}_{n} , {x}_{n} + {mvx}_{n} ) - {cov}_{w} ( {w}_{n} , {x}_{n} , {y}_{n} ) {cov}_{w} ( {w}_{n} , {x}_{n} , {x}_{n} + {mvx}_{n} )}{{var}_{w} ( {w}_{n} , {x}_{n} ) {var}_{w} ( {w}_{n} , {y}_{n} ) - {{cov}_{w} ( {w}_{n} , {x}_{n} , {y}_{n} )}^{2}} \\ {a}_{0} = \overline{{w}_{n} \cdot ( {x}_{n} + {mvx}_{n} )} - \overline{{w}_{n} \cdot {x}_{n}} \cdot {a}_{1} - \overline{{w}_{n} \cdot {y}_{n}} \cdot {a}_{2} \\ {b}_{1} = \frac{{var}_{w} ( {w}_{n} , {y}_{n} ) {cov}_{w} ( {w}_{n} , {x}_{n} , {y}_{n} + {mvy}_{n} ) - {cov}_{w} ( {w}_{n} , {x}_{n} , {y}_{n} ) {cov}_{w} ( {w}_{n} , {y}_{n} , {y}_{n} + {mvy}_{n} )}{{var}_{w} ( {w}_{n} , {x}_{n} ) {var}_{w} ( {w}_{n} , {y}_{n} ) - {{cov}_{w} ( {w}_{n} , {x}_{n} , {y}_{n} )}^{2}} \\ {b}_{2} = \frac{{var}_{w} ( {w}_{n} , {x}_{x} ) {cov}_{w} ( {w}_{n} , {y}_{n} , {y}_{n} + {mvy}_{n} ) - {cov}_{w} ( {w}_{n} , {x}_{n} , {y}_{n} ) {cov}_{w} ( {w}_{n} , {x}_{n} , {y}_{n} + {mvy}_{n} )}{{var}_{w} ( {w}_{n} , {x}_{n} ) {var}_{w} ( {w}_{n} , {y}_{n} ) - {{cov}_{w} ( {w}_{n} , {x}_{n} , {y}_{n} )}^{2}} \\ {b}_{0} = \overline{{w}_{n} \cdot ( {y}_{n} + {mvy}_{n} )} - \overline{{w}_{n} \cdot {x}_{n}} \cdot {b}_{1} - \overline{{w}_{n} \cdot {y}_{n}} \cdot {b}_{2} \qquad ( 8 )$$

Here, the variance and the covariance in equation (8) are defined as in equations (9) and (10) below, respectively.

$$\begin{matrix}{var}_{w} ( {w}_{n} , {a}_{n} ) = \frac{\sum {w}_{n} \cdot {( {a}_{n} - \overline{{a}_{n}} )}^{2}}{\sum {w}_{n}} & ( 9 ) \\ {cov}_{w} ( {w}_{n} , {a}_{n} , {b}_{n} ) = \frac{\sum {w}_{n} \cdot ( {a}_{n} - \overline{{a}_{n}} ) \cdot ( {b}_{n} - \overline{{b}_{n}} )}{\sum {w}_{n}} & ( 10 )\end{matrix}$$

As described above, the representative vector of the object having a small motion is given a priority and applied to the GMV by setting weighting to the cost C based on the magnitude of the motion vector per cluster and calculating the coefficients.

### [Method of Calculating Optimal Coefficient Using Projective Transformation]

The description above pertains to the case that the optimal coefficient calculation unit 101 obtains the motion vector using affine transformation, however, projective transformation may be employed instead of the affine transformation. In this case, the optimal coefficient calculation unit 101 calculates the optimal coefficients using the projective transformation by the process to be described below.

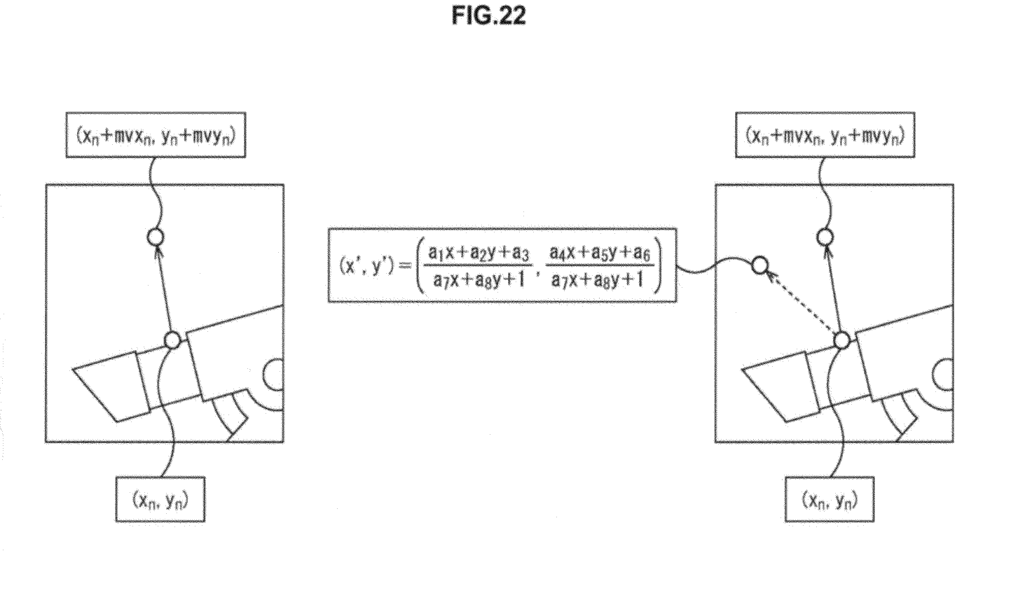

For example, as shown in a left portion of FIG. 22, when one point within the image is considered as the reference point (xₙ, yₙ) and a motion vector at this point is a motion vector (mvxₙ, mvyₙ), the reference point (xₙ, yₙ) is expressed as a moved point (xₙ+mvxₙ, yₙ+mvyₙ) when the reference point is moved by the motion vector. In addition, n denotes the identifier that identifies each cluster.

However, it is considered that this moved point (xₙ+mvxₙ, yₙ+mvyₙ) is moved to a transformation point (x′ₙ, y′ₙ) by the motion vector represented as a dotted line when seen from a right portion of FIG. 22 by means of affine transformation. Here, x and y coordinates of the transformation point are expressed as equation (11) below.

$$\{ \begin{matrix}{x}^{′} = \frac{{a}_{1} x + {a}_{2} y + {a}_{3}}{{a}_{7} x + {a}_{8} y + 1} \\ {y}^{′} = \frac{{a}_{4} x + {a}_{5} y + {a}_{6}}{{a}_{7} x + {a}_{8} y + 1}\end{matrix} \qquad ( 11 )$$

Here, in equation (11), an identifier n is not denoted, and each of a₀ to a₈ indicates a coefficient when the reference point is projective-transformed to the transformation point. In addition, the coordinate at the time of performing the projective transformation is expressed with the identifier n attached in the right portion of FIG. 22.

By substituting the motion vectors (X₁, Y₁), (X₂, Y₂), (X₃, Y₃), . . . of respective blocks clustered by the clustering unit 42 into equation (11) above, the following matrix equation (12) is generated.

$$( \begin{matrix}{X}_{1} \\ {Y}_{1} \\ {X}_{2} \\ {Y}_{2} \\ ⋮\end{matrix} ) = ( \begin{matrix}{x}_{1} & {y}_{1} & 1 & 0 & 0 & 0 & - {X}_{1} {x}_{1} & - {X}_{1} {y}_{1} \\ 0 & 0 & 0 & {x}_{1} & {y}_{1} & 1 & - {Y}_{1} {x}_{1} & - {Y}_{1} {y}_{1} \\ {x}_{2} & {y}_{2} & 1 & 0 & 0 & 0 & - {X}_{2} {x}_{2} & - {X}_{2} {y}_{2} \\ 0 & 0 & 0 & {x}_{2} & {y}_{2} & 1 & - {Y}_{2} {x}_{2} & - {Y}_{2} {y}_{2} \\ & & & & & ⋮ & & \end{matrix} ) ( \begin{matrix}{a}_{1} \\ {a}_{2} \\ {a}_{3} \\ {a}_{4} \\ {a}_{5} \\ {a}_{6} \\ {a}_{7} \\ {a}_{8}\end{matrix} ) \qquad ( 12 )$$

This can be abbreviated as equation (13) below.

p=(A^{T}A)⁻¹ A^{T}q (14)

Here, q indicates the left side of equation (12), A indicates the first matrix on the right side in equation (12), and p indicates the vector having coefficients a₀ to a₈ in equation (12).

By transforming equation (13) into equation (14) below and specifying each value of the coefficients a₀ to a₈ constituting the vector p, optimal coefficients are calculated.

p=(A^{T}A)⁻¹ A^{T}q (14)

Here, (A^{T}A) indicates equation (15) below, and A^{T}q indicates equation (16) below.

$${A}^{T} A = ( \begin{matrix}\sum {x}^{2} & \sum xy & \sum x & 0 & 0 & 0 & \sum - {Xx}^{2} & \sum - Xxy \\ \sum xy & \sum {y}^{2} & \sum y & 0 & 0 & 0 & \sum - Xxy & \sum - {Xy}^{2} \\ \sum x & \sum y & \sum 1 & 0 & 0 & 0 & \sum - Xx & \sum - Xy \\ 0 & 0 & 0 & \sum {x}^{2} & \sum xy & \sum x & \sum - {Yx}^{2} & \sum - Yxy \\ 0 & 0 & 0 & \sum xy & \sum {y}^{2} & \sum y & \sum - Yxy & \sum - {Yy}^{2} \\ 0 & 0 & 0 & \sum x & \sum y & \sum 1 & \sum - Yx & \sum - Yy \\ \sum - {Xx}^{2} & \sum - Xxy & \sum - Xx & \sum - {Yx}^{2} & \sum - Yxy & \sum - Yx & \sum {X}^{2} {x}^{2} + {Y}^{2} {x}^{2} & \sum {X}^{2} xy + {Y}^{2} xy \\ \sum - Xxy & \sum - {Xy}^{2} & \sum - Xy & \sum - Yxy & \sum - {Yy}^{2} & \sum - Yy & \sum {X}^{2} xy + {Y}^{2} xy & \sum {X}^{2} {y}^{2} + {Y}^{2} {y}^{2}\end{matrix} ) \qquad ( 15 )$$

$${A}^{T} q = ( \begin{matrix}\sum Xx \\ \sum Xy \\ \sum X \\ \sum Yx \\ \sum Yy \\ \sum Y \\ \sum - {X}^{2} x - {Y}^{2} x \\ \sum - {X}^{2} y - {Y}^{2} y\end{matrix} ) \qquad ( 16 )$$

As described above, the optimal coefficient calculation units 101-1 to 101-5 may calculate optimal coefficients that express representative vectors of the respective cluster using the projective transformation. As a result, it is possible to detect the proper motion vector even when imaging states such as rotation, zoom, and tilting are continuously changed at the time of capturing the image. In addition, the optimal coefficient calculation units 101-1 to 101-5 may be applied instead of the average value calculation units 43-1 to 43-5 even in the GMV calculation unit 23 of FIG. 12.

### 4. Fourth Embodiment

### [Image Coding Device Including a Selection Unit Using Zero Vector as Choice]

The description above pertains to the case that the LMV or the GMV detected by the GMV detection unit 23 is selected for each macroblock. However, any motion vector of the LMV and the GMV may not be correctly obtained due to an influence such as a flat portion or a noise. In this case, the coding accuracy may be degraded when any of the LMV and the GMV should be selected. The zero vector may be used as a choice in addition to the LMV and the GMV in accordance with determination of the motion vector per macroblock.

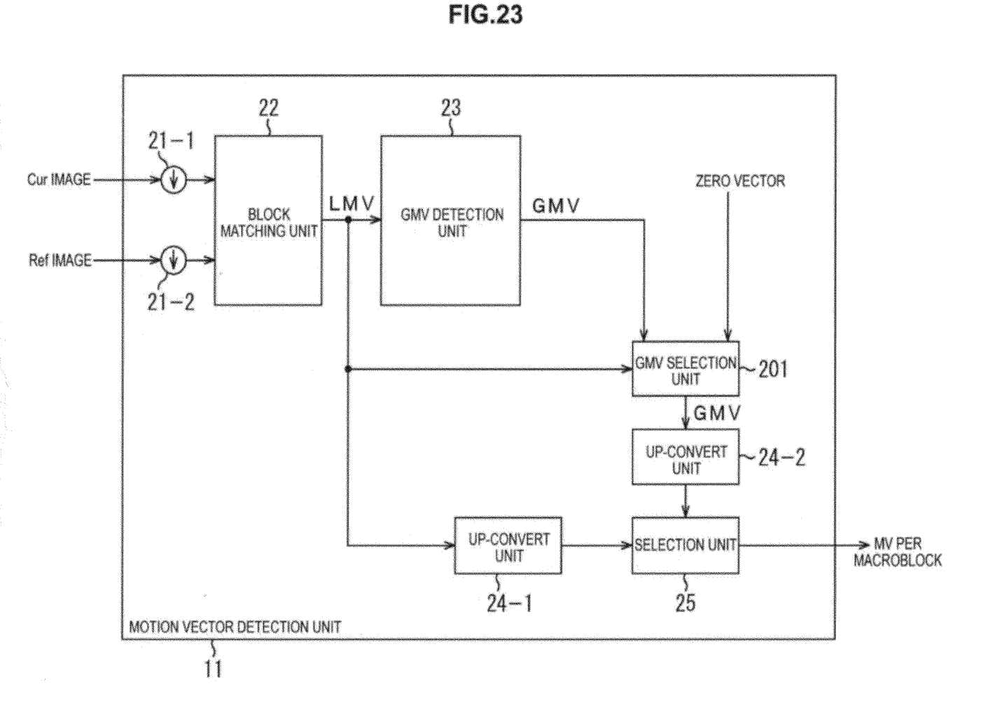

FIG. 23 illustrates an example configuration of the motion vector detection unit 11 that uses the zero vector as a choice in addition to the LMV and the GMV as a motion vector per macroblock. In addition, parts of the configuration that have the same functions as in the configuration of the motion vector detection unit 11 of FIG. 2 among configurations in the motion vector detection unit 11 of FIG. 23 is denoted with the same names and the same reference numerals, and redundant descriptions are appropriately omitted.

That is, the motion vector detection unit 11 of FIG. 23 differs from the motion vector detection unit 11 of FIG. 2 in that a GMV selection unit 201 is newly disposed.

The GMV selection unit 201 compares the LMV supplied from the block matching unit 22 with the GMV supplied from the GMV detection unit 23, and decides whether or not the LMV and the GMV match each other to a predetermined degree or higher. When the motion vectors match each other, the GMV selection unit 201 selects any of the motion vectors having a low accuracy as a zero vector, and otherwise outputs the GMV supplied from the GMV detection unit 23.

### [Coding Process in Image Coding Device Including Motion Vector Detection Unit of FIG. 23]

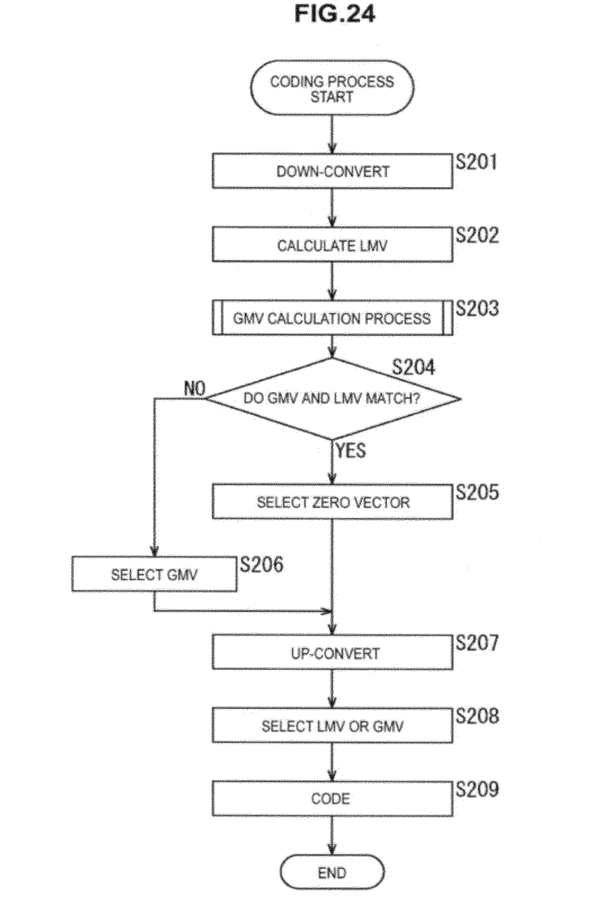

Next, the coding process in the image coding device 1 including the motion vector detection unit 11 of FIG. 23 will be described with reference to a flowchart of FIG. 24. In addition, except for the processes of step S204 to step S206, the processes of step S201 to step S209 in the flowchart of FIG. 24 are same as the processes of step S11 to step S16 described with reference to the flowchart of FIG. 6, and thus their description will not be repeated.

That is, the LMV is obtained in the block matching unit 22 and the GMV is obtained in the GMV detection unit 23 in the processes of step S201 to step S203, and the process proceeds to step S204.

In step S204, the GMV selection unit 201 decides whether the LMV per macroblock supplied from the block matching unit 22 and the GMV supplied from the GMV detection unit 23 match each other based on whether or not a distance between the LMV and the GMV is zero or about zero.

In step S204, for example, when the distance between the LMV and the GMV is regarded as zero which is smaller than a predetermined threshold value, or a value close to an approximate zero, or when the LMV and the GMV are regarded as approximately matching each other or matching each other, the process proceeds to step S205.

In step S205, the GMV selection unit 201 outputs the zero vector for which the accuracy of both of the LMV and the GMV is low as the GMV.

On the other hand, in step S204, when the distance between the LMV and the GMV is smaller than the predetermined threshold value and is not zero but close to approximate zero, that is, when the LMV and the GMV do not match each other, the process proceeds to step S206.

In step S206, the GMV selection unit 201 outputs the GMV supplied from the GMV detection unit 23 as is.

According to the process described above, the zero vector is output as the GMV even when the LMV or the GMV is not correctly obtained due to the influence such as a flat portion or a noise, it is thus possible to prevent the coding accuracy from being unnecessarily and largely decreased.

### 5. Fifth Embodiment>

### [Image Coding Device Including Selection Unit Selecting Zero Vector as Choice for GMV and Obtaining Object Motion Vector]

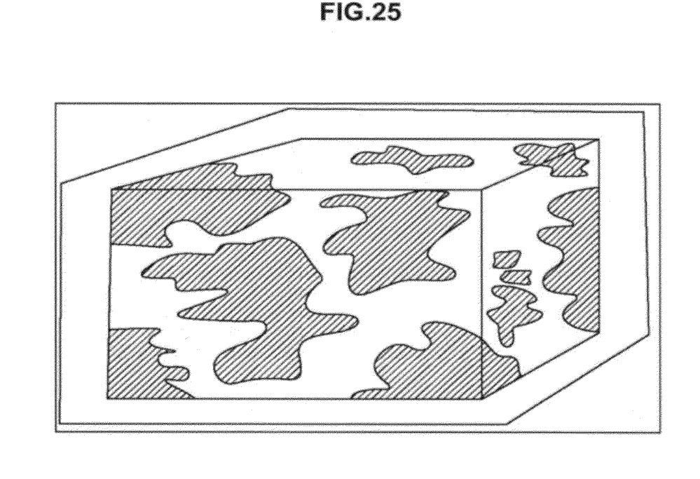

The description above pertains to the case that motions of respective objects are not changed while an imaging direction is changed when a plurality of objects are present within an image. However, for example, as shown in FIG. 25, when a cubic object having spot patterns on each side surface is captured while the imaging location is changed, each surface of the cubic object moves differently, it is thus not possible to express the object having spot patterns with one motion vector even when the affine transformation or the like is applied to. The motion vector corresponding to the GMV may thus be output as an object motion vector ObjectMV per object (hereinafter, also referred to as an ObjectMV for simplicity).

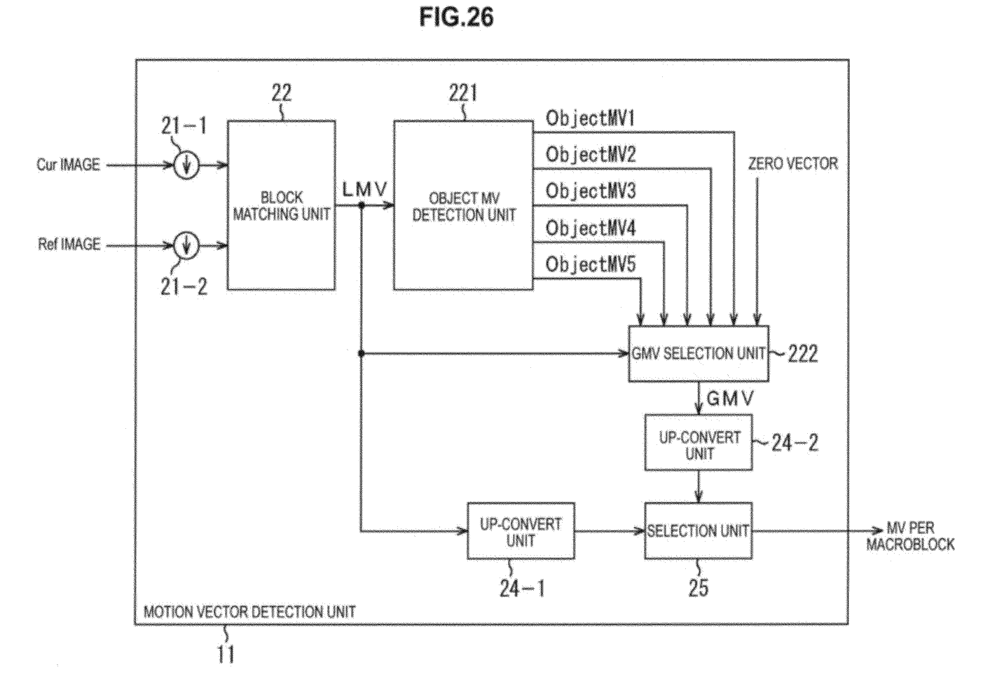

FIG. 26 illustrates an example configuration of the motion vector detection unit 11 of the image coding device 1 that outputs the ObjectMV corresponding to the GMV per object that is present within the image. In addition, parts of the configuration that have the same functions as in the configuration of the motion vector detection unit 11 of FIG. 2 among the configurations of the motion vector detection unit 11 of FIG. 26 is denoted with the same names and the same reference numerals, and redundant descriptions are appropriately omitted. That is, the motion vector detection unit 11 of FIG. 26 differs from the motion vector detection unit 11 of FIG. 2 in that an object MV detection unit 221 and an GMV selection unit 222 are newly disposed.

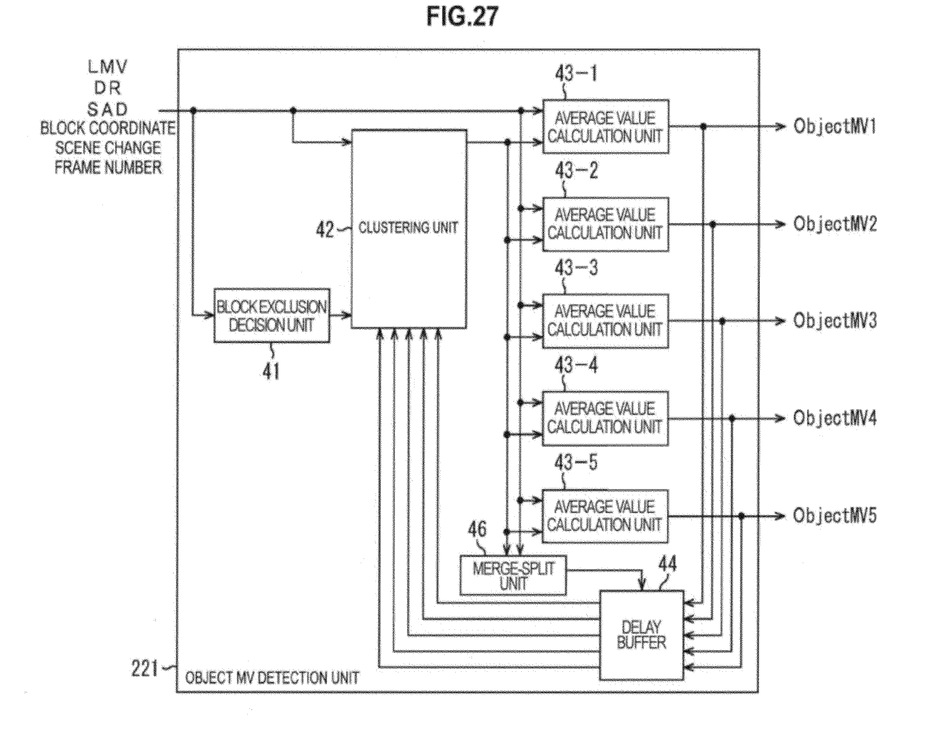

The object MV detection unit 221 detects the ObjectMV per object included within the image based on the LMV per macroblock supplied from the block matching unit 22, and supplies the ObjectMV along with information of the number of elements of the LMVs constituting the ObjectMV to the GMV selection unit 222. In addition, the object motion vectors ObjectMV1 to ObjectMV5 are output in FIG. 26, however, the number of the objects may be different. In addition, the configuration of the object MV detection unit 221 will be described below in detail with reference to FIG. 27.

The GMV selection unit 222 compares the LMV and the ObjectMV1 to ObjectMV5 supplied from the object MV detection unit 221 and the zero vector, and outputs any one of them as the GMV.

### [Object MV Detection Unit]

Next, an example configuration of the object MV detection unit 221 will be described with reference to FIG. 27. In addition, parts of the configuration that have the same function as the GMV detection unit 23 of FIG. 3 in the object MV detection unit 221 of FIG. 27 are denoted with the same names and the same reference numerals, and redundant descriptions are appropriately omitted. That is, the GMV determination 45 is removed from the GMV detection unit 23 of FIG. 3 in the object MV detection unit 221 of FIG. 27. Average values of LMVs constituting the clusters output from the average value calculation units 43-1 to 43-5 are output as ObjectMV1 to ObjectMV5, respectively.

### [Image Coding Process in Image Coding Device of FIG. 26]

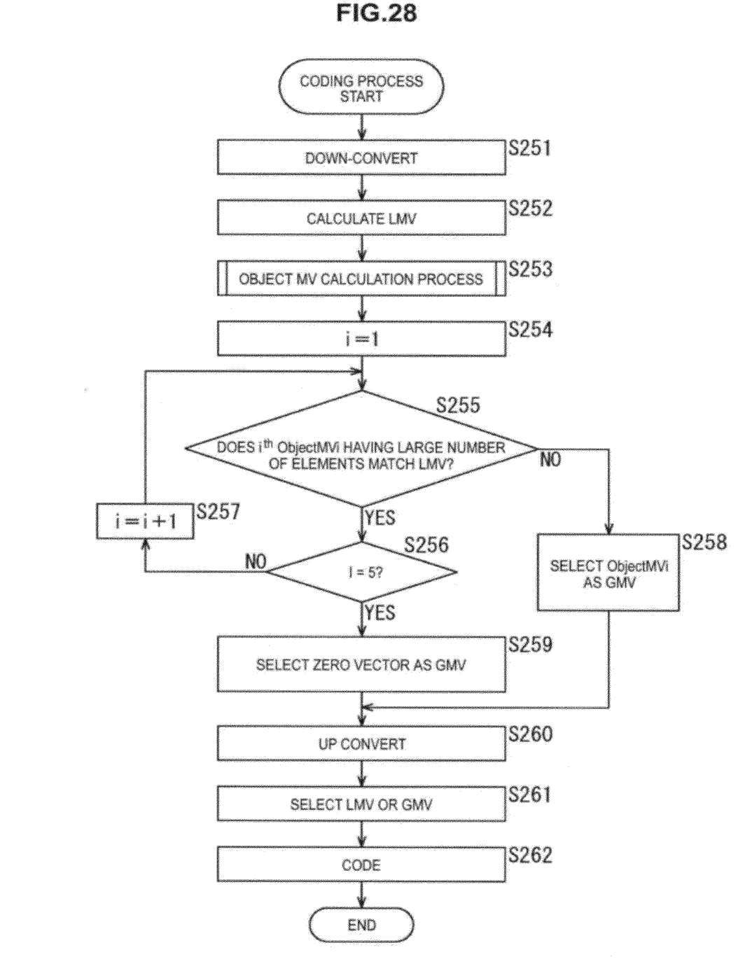

Next, the coding process in the image coding device 1 of FIG. 26 will be described with reference to a flowchart of FIG. 28. In addition, the processes of step S251 to step S257, excluding step S253 to step S259, in the flowchart of FIG. 28 are same as the processes of step S11 to S16, excluding step S13, in the flowchart of FIG. 6, and thus their description will not be repeated.

That is, in step S253, the object MV detection unit 221 carries out the object MV calculation process to detect object motion vectors ObjectMV1 to ObjectMV5 that are object motion vectors and supply the object motion vectors to the GMV selection unit 222.

### [Object MV Detection Process]

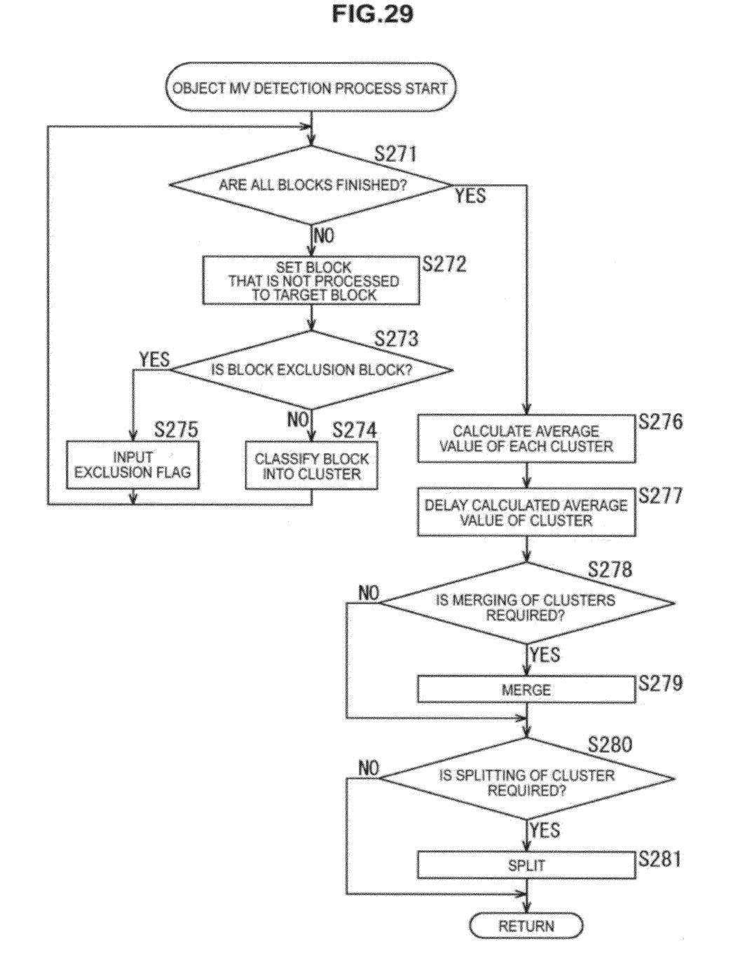

Here, the object MV detection process will be described with reference to a flowchart of FIG. 29. In addition, processes of step S271 to S281 in the flowchart of FIG. 29 correspond to the processes of step S31 to S42, excluding the process of step S37, of the GMV determination process described with reference to the flowchart of FIG. 7, and thus their description will not be repeated. That is, in the GMV determination process described with reference to the flowchart of FIG. 7, the GMV is not determined, but the representative vectors obtained as average values of the respective clusters are detected as ObjectMV1 to ObjectMV5 and supplied to the GMV selection unit 222. In this case, the average value calculation units 43-1 to 43-5 supply not only the ObjectMV1 to ObjectMV5 that are calculated representative vectors of the respective clusters but also the information of the number of elements of LMVs used to calculate the respective ObjectMV1 to ObjectMV5 to the GMV selection unit 222.

Here, the process returns to the description of the flowchart of FIG. 28.

In step S254, the GMV selection unit 222 initializes the count i for counting the rank to 1.

In step S255, the GMV selection unit 222 calculates a distance between the ObjectMVi having a high i-th rank as the number of elements among the ObjectMV1 to ObjectMV5 and the LMV, and decides whether or not the ObjectMVi and the LMV match each other when the distance is smaller than a predetermined value and sufficiently close to 0. In step S255, for example, when it is decided that the reliability of the ObjectMVi and the LMV is low because the distance between the ObjectMVi and the LMV is sufficiently close to 0 and the ObjectMVi and the LMV thus match each other, the process proceeds to step S256.

In step S256, the GMV selection unit 222 decides whether or not the count i is the maximum number, that is, 5. In step S256, for example, when the count i is not 5, that is, when it is decided that the ObjectMV having a lower rank as the number of elements is still present, the GMV selection unit 222 increments the count i by 1 in step S257, and the process returns to step S255. That is, from then on, it is decided whether or not the ObjectMVi having a lower rank as the number of elements match the LMV, and the process of step S255 to S257 is repeatedly carried out until it is considered that matching does not occur by the count number one from the higher rank with respect to the remaining ObjectMVs in step S255. When the count i is 5, in step S256, that is, when comparison between all ObjectMVs and the LMV is completed and the ObjectMV that is not matched is regarded as not being present, the process proceeds to step S259.

In step S259, the GMV selection unit 222 supplies the zero vector to the up-convert unit 24-2 as GMV.

On the other hand, in step S255, for example, when the ObjectMVi and the LMV do not match each other, the GMV selection unit 222 outputs the ObjectMVi to the up-convert unit 24-2 as GMV.

That is, when it is decided whether or not the ObjectMVi and the LMV match each other from a higher rank as the number of elements and the ObjectMVi that does not match the LMV is present, the ObjectMVi is output as GMV. Finally, when the ObjectMVi having the smaller number of elements and the LMV match each other, the GMV selection unit 222 outputs the zero vector as GMV.

As a result, the erroneous LMV due to an influence such as a flat portion or a noise is not selected but the zero vector is selected as GMV, it is thus possible to suppress the coding accuracy from being reduced. In addition, a suitable ObjectMV of the object is selected as GMV in each of the imaging directions even when the cubic object as shown in FIG. 25 is continuously captured while the imaging direction is changed, it is thus possible to code the image with a good accuracy.

In addition, the description above pertains to the case that the distance between the LMV and each of the ObjectMVs in a rank having a larger number of elements is obtained, and is not obtained when the distance has a small value, that is, the ObjectMV at the rank when the LMV and the ObjectMV do not match each other to some degree is selected as GMV, however, for example, when the distance between the ObjectMV and the LMV is greater than a predetermined distance, the ObjectMV may be selected as GMV. In addition, at least two ObjectMVs among plural ObjectMVs may be output as candidates for GMV and the selection unit 25 may finally select the GMV. In addition, the description has been made with the ObjectMV1 to ObjectMV5 and the zero vector as choices for GMV, however, at least five kinds of ObjectMVs may also be selected, and plural ObjectMVs excluding the zero vector may also be used.

### 6. Sixth Embodiment

### [Image Coding Device Including Zero Vector as Object Motion Vector]

The description above pertains to the case that one GMV is supplied to the selection unit 25, however, all of the ObjectMV1 to ObjectMV5 and the zero vector may be supplied to the selection unit 25 as candidates for GMV, and the selection unit 25 may select the GMV based on the SATD and the information of the overhead portion.

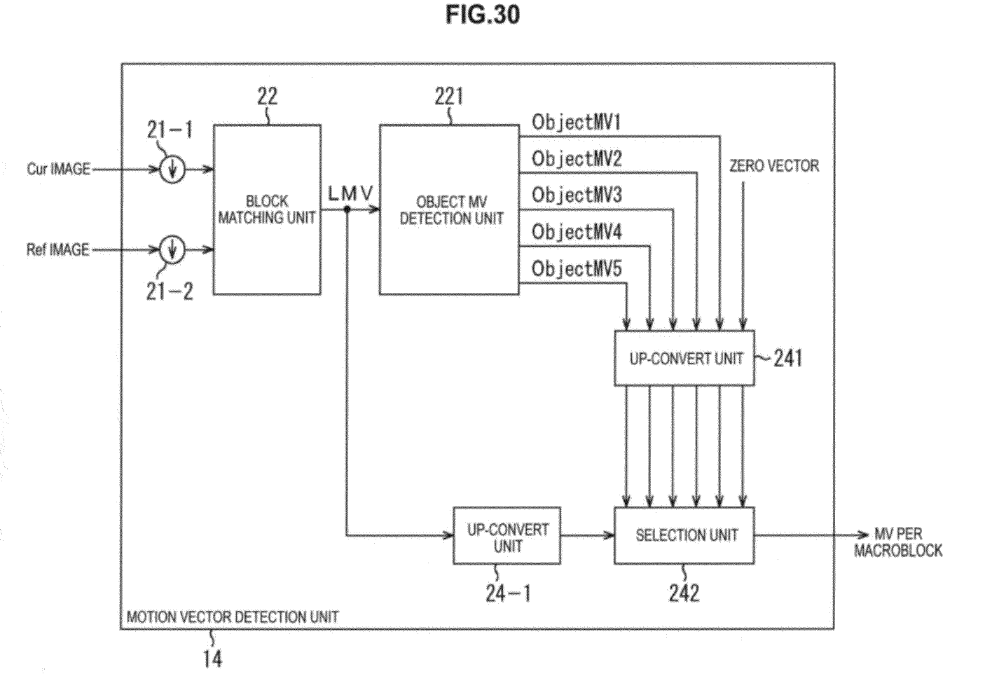

FIG. 30 illustrates an example configuration of the motion vector detection unit 11 of the image coding device 1 that supplies all of the ObjectMV1 to ObjectMV5 and the zero vector to the selection unit 25 as candidates for GMV. In addition, parts of the configuration that have the same functions as in the configuration of the motion vector detection unit 11 of FIG. 26 in the motion vector detection unit 14 of FIG. 30 are denoted with the same names and the same reference numerals, and redundant descriptions are appropriately omitted. That is, the motion vector detection unit 14 of FIG. 30 differs from the motion vector detection unit 11 of FIG. 26 in that an up-convert unit 241 and a selection unit 242 are disposed instead of the GMV selection unit 222, the up-convert unit 24-2 and the selection unit 25.

The up-convert unit 241 has a basic function similar to the up-convert unit 24-2, however, up-converts and supplies all of the object motion vectors ObjectMV1 to ObjectMV5 and the zero vector to the selection unit 25.

The selection unit 242 has a basic function similar to the selection unit 25, however, obtains the SATD and the information of the overhead portion per block with respect to all of the LMV and the ObjectMV1 to ObjectMV5 that are up-converted, and selects any of the motion vectors having the smallest value as the motion vector per block.

### [Image Coding Process of Image Coding Device Including Motion Vector Detection Unit of FIG. 30]

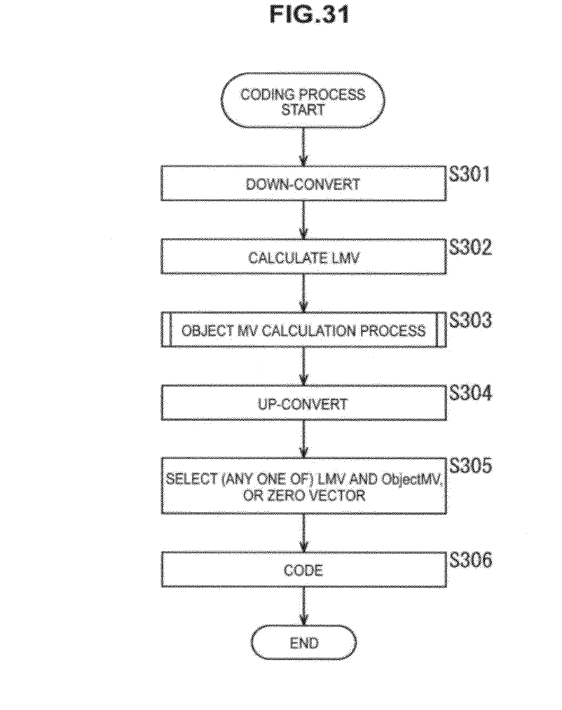

Next, the image coding process of the image coding device including the motion vector detection unit of FIG. 30 will be described with reference to a flowchart of FIG. 31. In addition, the processes of step S301 to step S306, excluding step S304 and step S305, of the flowchart of FIG. 31 are same as the processes of steps S11 to S16, excluding step S14 and step S15, of the flowchart of FIG. 6, and thus their description will not be repeated. In addition, the process of step S303 in the flowchart of FIG. 31 is same as the process of step S253 in the flowchart of FIG. 28, and thus its description will not be repeated.

That is, when the LMV and the object motion vectors ObjectMV1 to ObjectMV5 are detected in the processes of step S301 to step S303, the process proceeds to step S304. In step S304, the up-convert unit 241 up-converts the object motion vectors ObjectMV1 to ObjectMV5 and the zero vector using the information of which the resolution becomes a higher resolution of the input Cur image and the Ref image, and supplies the object motion vectors and the zero vector to the selection unit 25.

In step S305, the selection unit 242 obtains the SATD and the information of the overhead portion when the LMV, the ObjectMV1 to ObjectMV5, and the zero vector that are up-converted to have the resolution of the input Cur image per macroblock are used, and selects and outputs any small motion vector to the coding unit 12 as the motion vector per block.

According to the processes described above, the motion vector for which the SATD and the information of the overhead portion are minimized when each of the LMV, the ObjectMV1 to ObjectMV5 and the zero vector is used is selected per block, it is thus possible to code the image without reducing the coding accuracy even when the LMV is false detected due to an influence such as a flat portion or a noise. In addition, the description above pertains to the case that the LMV, the ObjectMV1 to ObjectMV5 and the zero vector are used as choices for GMV. However, at least five kinds of ObjectMVs may be used as choices, and plural LMV and ObjectMVs excluding the zero vector may also be used as choices.

In addition, the description above pertains to the case that all of the ObjectMV1 to ObjectMV5 and the zero vector are up-converted and supplied to the selection unit 242. However, for example, the ObjectMVs up to high n^{th} ranks (n=1, 2, 3, or 4) of the number of elements or the ObjectMVs up to high n^{th} ranks (n=1, 2, 3, or 4) in an order of which the distance to the LMV is farther, which are added with the zero vector, may also be supplied to the up-convert unit 241. In addition, the description pertains to the case that the motion vector for which the SATD and the information of the overhead portion are minimized when each of the LMV, the ObjectMV1 to ObjectMV5 and the zero vector is used is selected as a motion vector per macroblock. However, a plurality of motion vectors up to the high n^{th} ranks in an order in which the SATD and the information of the overhead portion are smaller may be used as motion vectors of the macroblock to be processed.

According to the processes described above, it is possible to properly detect the object motion vector even when a plurality of objects moves differently. In addition, it is possible to enhance the coding efficiency by selecting the proper GMV and coding the image. In addition, it is possible to enhance the quality of interpolation frame when the image information is transformed at a high frame rate.

The series of processes described above may be executed by hardware, however they may also be executed by software. When the series of processes are executed by the hardware, the program constituting the software is installed on, for example, a computer having a built-in dedicated hardware or a general purpose computer capable of installing various programs and executing various functions from a recording medium.

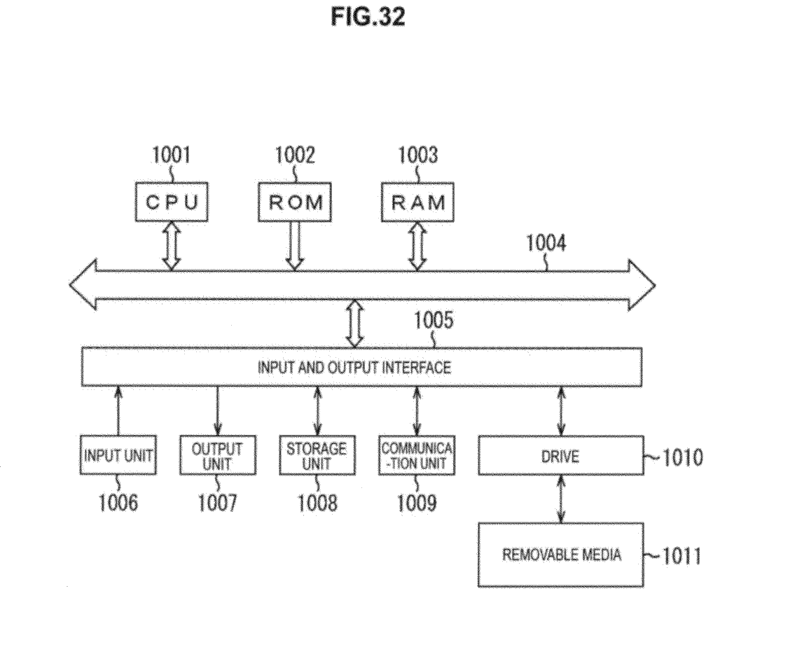

FIG. 32 illustrates an example configuration of the general purpose personal computer. This personal computer has a built-in central processing unit (CPU) 1001. An input and output interface 1005 is connected to the CPU 1001 via a bus 1004. A read only memory (ROM) 1002 and a random access memory (RAM) 1003 are connected to the bus 1004.

An input unit 1006 acting as an input device such as a keyboard on which a user inputs an operation command, or a mouse, an output unit 1007 outputting a process operation screen or a processed result image to a display device, a storage unit 1008 such as a hard disk drive storing programs or various data, and a communication unit 1009 such as a local area network (LAN) adapter carrying out a communication process via a network represented as Internet, are connected to the input and output interface 1005. In addition, a magnetic disk (including a flexible disk), an optical disk (including compact disk-read only memory (CD-ROM) and a digital versatile disk (DVD)), an magneto-optical disk (including a mini disk (MD)), or a drive 1010 reading and writing data with respect to a removable drive 1011 such as a semiconductor memory, are connected to the bus.

The CPU 1001 executes various processes in accordance with the program stored in the ROM 1002, or the program that is read out from the magnetic disk, the optical disk, the magneto-optical disk, or the removable disk 1011 such as a semiconductor memory, installed in the storage unit 1008, and loaded onto the RAM 1003 from the storage unit 1008. Data or the like used to execute various processes in the CPU 1001 are also properly stored in the RAM 1003.

In the present specification, steps describing the program stored in the recording medium include not only processes carried out in time-series in the described order but also processes carried out in parallel or individually even when the processes are not necessarily carried out in time-series.

Additionally, the present technology may also be configured as below.
(1) An image processing device including:

a local motion vector detection unit configured to detect a local motion vector per block using block matching between an input image and a reference image;

a clustering unit configured to cluster the local motion vector per block into a predetermined number of clusters based on a distance between the local motion vector per block and a vector set for each of the predetermined number of clusters;

a representative calculation unit configured to calculate a representative local motion vector representing each cluster made by the clustering unit; and

a global motion vector selection unit configured to select a global motion vector of the input image from the representative local motion vectors of the respective clusters based on the number of local motion vectors in each cluster.
(2) The image processing device according to (2), wherein

the clustering unit comprises a distance calculation unit configured to calculate a distance between the local motion vector per block and a vector set for each of a predetermined number of clusters and to cluster the local motion vectors per blocks into a cluster for which the distance calculated by the distance calculation unit is shortest.
(3) The image processing device according to (1) or (2), wherein

the representative calculation unit calculates an average value of the local motion vectors in a cluster made by the clustering unit as the representative local motion vector of the cluster.
(4) The image processing device according to any one of (1) to (3), wherein

the representative calculation unit calculates a vector specified by an affine transformation parameter of the local motion vectors in a cluster made by the clustering unit or a projective transformation parameter as the representative local motion vector, and the affine transformation parameter or the projective transformation parameter is obtained by an affine transformation or a projective transformation in response to the input image.
(5) The image processing device according to any one of (2) to (4), further including:

a buffering unit configured to buffer the average value of the local motion vectors of each cluster made by the clustering unit, or the vector specified by the affine transformation parameter or the projective transformation parameter, the average value and the vector being calculated by the representative calculation unit,

wherein the clustering unit clusters the local motion vectors by using the average value of the local motion vectors of each cluster made by the clustering unit, or the vector specified by the affine transformation parameter or the projective transformation parameter, which are buffered in the buffering unit, as vectors to be set for each cluster.
(6) The image processing device according to any one of (1) to (5), further including:

a merge-split unit configured to merge clusters whose locations within a vector space between each cluster are close to each other among the clusters made by the clustering unit and to split clusters having a large variance within the vector space between each pixel into a plurality of clusters.
(7) The image processing device according to any one of (1) to (6), further including:

a first down-convert unit configured to down-convert the input image into an image having a lower resolution;

a second down-convert unit configured to down-convert the reference image into an image having a lower resolution;

a first up-convert unit configured to apply the local motion vector per block obtained from the image having the lower resolution, when the image having the lower resolution is set to have a resolution of the input image, to the block when a resolution returns to the resolution of the input image;

a second up-convert unit configured to apply the global motion vector obtained from the image having the lower resolution, when the image having the lower resolution is set to have a resolution of the input image, to the block when a resolution returns to the resolution of the input image; and

a selection unit configured to select one of the local motion vector and the global motion vector with respect to the block of the input image by comparing a sum-of-absolute-difference between pixels per block of the input image to which a local motion vector is applied by the first up-convert unit and pixels per block of the reference image corresponding to the block, with a sum-of-absolute-difference between pixels per block of the input image to which the global motion vector is applied by the second up-convert unit and pixels per block of the reference image corresponding to the block.
(8) An image processing method including:

detecting a local motion vector per block using block matching between an input image and a reference image, in a local motion vector detection unit configured to detect the local motion vector per block using block matching between the input image and the reference image;

clustering the local motion vector per block into a predetermined number of clusters based on a distance between the local motion vector per block and a vector set for each of the predetermined number of clusters, in a clustering unit configured to cluster the local motion vector per block into the predetermined number of clusters;

calculating a representative local motion vector representing each cluster made in the clustering step, in a representative calculation unit configured to calculate the representative local motion vector representing each cluster made by the clustering unit; and

selecting a global motion vector of the input image from the representative local motion vectors of the respective clusters based on the number of local motion vectors in each cluster, in a global motion vector selection unit configured to select the global motion vector of the input image from the representative local motion vectors of the respective clusters based on the number of local motion vectors in each cluster.
(9) A program for causing a computer including an image processing device to execute processes, the image processing device including:

a local motion vector detection unit configured to detect a local motion vector per block using block matching between an input image and a reference image;

a clustering unit configured to cluster the local motion vector per block into a predetermined number of clusters based on a distance between the local motion vector per block and a vector set for each of the predetermined number of clusters;

a representative calculation unit configured to calculate a representative local motion vector representing each cluster made by the clustering unit; and

a global motion vector selection unit configured to select a global motion vector of the input image from the representative local motion vectors of the respective clusters based on the number of local motion vectors in each cluster, and

the processes including,
detecting the local motion vector per block using block matching from the input image and the reference image, in the local motion vector detection unit;
clustering the local motion vector per block into the predetermined number of clusters based on the distance between the local motion vector per block and a vector set for each of the predetermined number of clusters, in the clustering unit;
calculating the representative local motion vector representing each cluster made in the clustering step, in the representative calculation unit; and
selecting a global motion vector of the input image from the representative local motion vectors of the respective clusters based on the number of local motion vectors in each cluster, in the global motion vector selection unit.
(10) An image processing device including:

a local motion vector detection unit configured to detect a local motion vector per block using block matching between an input image and a reference image;

a clustering unit configured to cluster the local motion vector per block for each of a predetermined number of objects based on a distance between the local motion vector per block and a vector set for each of the predetermined number of objects; and

an object motion vector calculation unit configured to calculate an object motion vector based on the local motion vector for each of the objects classified by the clustering unit.
(11) The image processing device according to (10), further including:

a global motion vector selection unit configured to select a global motion vector of the input image from the calculated object motion vectors based on the local motion vector clustered for each of the objects.
(12) An image processing method including:

detecting a local motion vector per block using block matching from an input image and a reference image, in a local motion vector detection unit configured to detect a local motion vector per block using block matching between the input image and the reference image;

clustering the local motion vector per block for each of a predetermined number of objects based on a distance between the local motion vector per block and a vector set for each of the predetermined number of objects, in a clustering unit configured to cluster the local motion vector per block for each of the predetermined number of objects based on the distance between the local motion vector per block and the vector set for each of the predetermined number of objects; and

calculating an object motion vector based on the local motion vector for each of the objects classified by the clustering unit, in an object motion vector calculation unit configured to calculate the object motion vector based on the local motion vector for each of the objects classified by the clustering unit.
(13) A program for causing a computer including an image processing device to execute processes, the image processing device including:

a local motion vector detection unit configured to detect a local motion vector per block using block matching between an input image and a reference image;

a clustering unit configured to cluster the local motion vector per block for each of a predetermined number of objects based on a distance between the local motion vector per block and a vector set for each of the predetermined number of objects; and

an object motion vector calculation unit configured to calculate an object motion vector based on the local motion vector for each of the objects classified by the clustering unit,

the processes including,
detecting a local motion vector per block using block matching from an input image and a reference image, in the local motion vector detection unit configured to detect the local motion vector per block using block matching between the input image and the reference image;
clustering the local motion vector per block for each of the predetermined number of objects based on the distance between the local motion vector per block and the vector set for each of the predetermined number of objects, in a clustering unit configured to cluster the local motion vector per block for each of the predetermined number of objects based on the distance between the local motion vector per block and the vector set for each of the predetermined number of objects; and
calculating an object motion vector based on the local motion vector for each of the objects classified by the clustering unit, in an object motion vector calculation unit configured to calculate the object motion vector based on the local motion vector for each of the objects classified by the clustering unit.

It should be understood by those skilled in the art that various modifications, combinations, sub-combinations and alterations may occur depending on design requirements and other factors insofar as they are within the scope of the appended claims or the equivalents thereof.

The present disclosure contains subject matter related to that disclosed in Japanese Priority Patent Application JP 2011-123193 filed in the Japan Patent Office on Jun. 1, 2011, the entire content of which is hereby incorporated by reference.

What is claimed is:

1. An image processing device comprising:
a clustering unit configured to cluster local motion vectors per blocks of an input image into a predetermined number of clusters; and
a global motion vector selection unit configured to set a representative local motion vector for each of the predetermined number of clusters made by the clustering unit and select a global motion vector of the input image from the representative local motion vectors of the respective clusters.

2. An image processing device comprising:
a local motion vector detection unit configured to detect a local motion vector per block using block matching between an input image and a reference image;
a clustering unit configured to cluster the local motion vector per block into a predetermined number of clusters based on a distance between the local motion vector per block and a vector set for each of the predetermined number of clusters;
a representative calculation unit configured to calculate a representative local motion vector representing each cluster made by the clustering unit; and
a global motion vector selection unit configured to select a global motion vector of the input image from the representative local motion vectors of the respective clusters based on the number of local motion vectors in each cluster.

3. The image processing device according to claim 2, wherein
the clustering unit comprises a distance calculation unit configured to calculate a distance between the local motion vector per block and a vector set for each of a predetermined number of clusters and to cluster the local motion vectors per blocks into a cluster for which the distance calculated by the distance calculation unit is shortest.

4. The image processing device according to claim 3, wherein
the representative calculation unit calculates an average value of the local motion vectors in a cluster made by the clustering unit as the representative local motion vector of the cluster.

5. The image processing device according to claim 4, wherein
the representative calculation unit calculates a vector specified by an affine transformation parameter of the local motion vectors in a cluster made by the clustering unit or a projective transformation parameter as the representative local motion vector, and the affine transformation parameter or the projective transformation parameter is obtained by an affine transformation or a projective transformation in response to the input image.

6. The image processing device according to claim 5, further comprising:
a buffering unit configured to buffer the average value of the local motion vectors of each cluster made by the clustering unit, or the vector specified by the affine transformation parameter or the projective transformation parameter, the average value and the vector being calculated by the representative calculation unit,
wherein the clustering unit clusters the local motion vectors by using the average value of the local motion vectors of each cluster made by the clustering unit, or the vector specified by the affine transformation parameter or the projective transformation parameter, which are buffered in the buffering unit, as vectors to be set for each cluster.

7. The image processing device according to claim 6, further comprising:
a merge-split unit configured to merge clusters whose locations within a vector space between each cluster are close to each other among the clusters made by the clustering unit and to split clusters having a large variance within the vector space between each pixel into a plurality of clusters.

8. The image processing device according to claim 7, further comprising:
a first down-convert unit configured to down-convert the input image into an image having a lower resolution;
a second down-convert unit configured to down-convert the reference image into an image having a lower resolution;
a first up-convert unit configured to apply the local motion vector per block obtained from the image having the lower resolution, when the image having the lower resolution is set to have a resolution of the input image, to the block when a resolution returns to the resolution of the input image;
a second up-convert unit configured to apply the global motion vector obtained from the image having the lower resolution, when the image having the lower resolution is set to have a resolution of the input image, to the block when a resolution returns to the resolution of the input image; and
a selection unit configured to select one of the local motion vector and the global motion vector with respect to the block of the input image by comparing a sum-of-absolute-difference between pixels per block of the input image to which a local motion vector is applied by the first up-convert unit and pixels per block of the reference image corresponding to the block, with a sum-of-absolute-difference between pixels per block of the input image to which the global motion vector is applied by the second up-convert unit and pixels per block of the reference image corresponding to the block.

9. An image processing method comprising:
detecting a local motion vector per block using block matching between an input image and a reference image, in a local motion vector detection unit configured to detect the local motion vector per block using block matching between the input image and the reference image;
clustering the local motion vector per block into a predetermined number of clusters based on a distance between the local motion vector per block and a vector set for each of the predetermined number of clusters, in a clustering unit configured to cluster the local motion vector per block into the predetermined number of clusters;
calculating a representative local motion vector representing each cluster made in the clustering step, in a representative calculation unit configured to calculate the representative local motion vector representing each cluster made by the clustering unit; and
selecting a global motion vector of the input image from the representative local motion vectors of the respective clusters based on the number of local motion vectors in each cluster, in a global motion vector selection unit configured to select the global motion vector of the input image from the representative local motion vectors of the respective clusters based on the number of local motion vectors in each cluster.

10. A program for causing a computer including an image processing device to execute processes, the image processing device including:
a local motion vector detection unit configured to detect a local motion vector per block using block matching between an input image and a reference image;
a clustering unit configured to cluster the local motion vector per block into a predetermined number of clusters based on a distance between the local motion vector per block and a vector set for each of the predetermined number of clusters;
a representative calculation unit configured to calculate a representative local motion vector representing each cluster made by the clustering unit; and
a global motion vector selection unit configured to select a global motion vector of the input image from the representative local motion vectors of the respective clusters based on the number of local motion vectors in each cluster, and
the processes comprising,
detecting the local motion vector per block using block matching from the input image and the reference image, in the local motion vector detection unit;
clustering the local motion vector per block into the predetermined number of clusters based on the distance between the local motion vector per block and a vector set for each of the predetermined number of clusters, in the clustering unit;
calculating the representative local motion vector representing each cluster made in the clustering step, in the representative calculation unit; and
selecting a global motion vector of the input image from the representative local motion vectors of the respective clusters based on the number of local motion vectors in each cluster, in the global motion vector selection unit.

11. A computer-readable recording medium having stored the program according to claim 10.

12. An image processing device comprising:
a local motion vector detection unit configured to detect a local motion vector per block using block matching between an input image and a reference image;
a clustering unit configured to cluster the local motion vector per block for each of a predetermined number of objects based on a distance between the local motion vector per block and a vector set for each of the predetermined number of objects; and
an object motion vector calculation unit configured to calculate an object motion vector based on the local motion vector for each of the objects classified by the clustering unit.

13. The image processing device according to claim 12, further comprising:
a global motion vector selection unit configured to select a global motion vector of the input image from the calculated object motion vectors based on the local motion vector clustered for each of the objects.

14. An image processing method comprising:
detecting a local motion vector per block using block matching from an input image and a reference image, in a local motion vector detection unit configured to detect a local motion vector per block using block matching between the input image and the reference image;
clustering the local motion vector per block for each of a predetermined number of objects based on a distance between the local motion vector per block and a vector set for each of the predetermined number of objects, in a clustering unit configured to cluster the local motion vector per block for each of the predetermined number of objects based on the distance between the local motion vector per block and the vector set for each of the predetermined number of objects; and
calculating an object motion vector based on the local motion vector for each of the objects classified by the clustering unit, in an object motion vector calculation unit configured to calculate the object motion vector based on the local motion vector for each of the objects classified by the clustering unit.

15. A program for causing a computer including an image processing device to execute processes, the image processing device including:
a local motion vector detection unit configured to detect a local motion vector per block using block matching between an input image and a reference image;
a clustering unit configured to cluster the local motion vector per block for each of a predetermined number of objects based on a distance between the local motion vector per block and a vector set for each of the predetermined number of objects; and
an object motion vector calculation unit configured to calculate an object motion vector based on the local motion vector for each of the objects classified by the clustering unit,
the processes comprising,
detecting a local motion vector per block using block matching from an input image and a reference image, in the local motion vector detection unit configured to detect the local motion vector per block using block matching between the input image and the reference image;
clustering the local motion vector per block for each of the predetermined number of objects based on the distance between the local motion vector per block and the vector set for each of the predetermined number of objects, in a clustering unit configured to cluster the local motion vector per block for each of the predetermined number of objects based on the distance between the local motion vector per block and the vector set for each of the predetermined number of objects; and
calculating an object motion vector based on the local motion vector for each of the objects classified by the clustering unit, in an object motion vector calculation unit configured to calculate the object motion vector based on the local motion vector for each of the objects classified by the clustering unit.

16. A computer-readable recording medium having stored the program according to claim 15.
